(19) United States
(12) Patent Application Publication
(10) Pub. No.: US 2010/0094727 A1
(43) Pub. Date: Apr. 15, 2010

(54) Method and System for Making Anonymous On-line Purchases

(76) Inventor: Peter A. Shapiro, Armonk, NY (US)

Correspondence Address: CHRISTINE JOHNSON ESQ., 151 Trenton Rd., Fairless Hills, PA, 19030, US

(21) Appl. No.: 12/443,827

(22) PCT Filed: Oct. 12, 2007
(86) PCT No.: PCT/US07/81287

§ 371 Date: Apr. 1, 2009

Related U.S. Application Data
(60) Provisional application No. 60/851,341, filed on Oct. 12, 2006.
(60) Provisional application No. 60/905,396, filed on Mar. 7, 2007.
(60) Provisional application No. 60/911,107, filed on Apr. 11, 2007.

(51) Int. Cl. G06Q 30/00; G06Q 20/00; G06F 15/16

(52) U.S. Cl. 705/27; 709/217

(57) ABSTRACT

The invention provides a system for effecting anonymous purchase of items from an online merchant system. A system according to an embodiment of the invention comprises means coupled to a merchant system for receiving price information from the merchant system about an item selected for purchase by a purchaser. The system further comprises means coupled to a purchaser system for receiving payment of the price from the purchaser. The system further comprises means for providing an anonymous identifier to the purchaser system in response to receiving the payment. The system further comprises means coupled to the merchant site for providing the payment to the merchant site and means coupled to the merchant site for providing the anonymous identifier to the merchant site. The merchant system provides the item to the purchaser in response to the purchaser providing the anonymous identifier to the merchant system. The purchaser thereby remains anonymous to the merchant.

### CROSS REFERENCE TO RELATED APPLICATIONS

This application claims the benefit of priority to the following U.S. provisional applications: 60/851,341 to Shapiro filed Oct. 12, 2006; 60/905,396 to Shapiro, filed Mar. 7, 2007 and 60/911,107 to Shapiro, filed Apr. 11, 2007, each of which is incorporated herein by reference in its entirety.

### FIELD OF THE INVENTION

The present invention relates generally to on line payment transactions between merchants and purchasers and more particularly to a system and method of effecting payments in such transactions such that the purchaser remains anonymous to the merchant.

### BACKGROUND OF THE INVENTION

Many online purchasers are concerned about providing personal and credit card information to online merchants. Concerns about fraudulent credit card use and disclosure of personal information deter some purchasers. Other purchasers wish to avoid Internet mailing lists. Maintaining privacy is becoming increasingly important to purchasers of online content. Many Internet purchasers are deterred from purchasing internet content from online merchants. They are simply not comfortable with what will become of their personal history of purchases.

Accordingly there is a need for a simple payment system that enables purchasers to securely effect payment for purchases from online merchants without exposing their credit card information to fraud. Also, there is a need to provide a simple online payment service that enables purchasers to anonymously and securely conduct online transactions and particularly to effect payments online.

### SUMMARY OF THE INVENTION

The invention provides a system for effecting anonymous purchase of items from an online merchant system. A system according to an embodiment of the invention comprises means coupled to a merchant system for receiving price information from the merchant system about an item selected for purchase by a purchaser. The system further comprises means coupled to a purchaser system for receiving payment of the price from the purchaser. The system further comprises means for providing an anonymous identifier to the purchaser system in response to receiving the payment. The system further comprises means coupled to the merchant site for providing the payment to the merchant site and means coupled to the merchant site for providing the anonymous identifier to the merchant site. The merchant system provides the item to the purchaser in response to the purchaser providing the anonymous identifier to the merchant system. The purchaser thereby remains anonymous to the merchant.

### DESCRIPTION OF THE DRAWING FIGURES

These and other objects, features and advantages of the invention will be apparent from a consideration of the following detailed description of the invention considered in conjunction with the drawing Figures, in which:

FIG. 1 is a block diagram illustrating a network suitable for implementing an anonymous payment system according to an embodiment of the invention.

FIG. 2 is a block diagram illustrating a system for making anonymous online purchases according to an embodiment of the invention wherein an anonymous payment system originates anonymous sign on information.

FIG. 3 is a flowchart illustrating steps of methods carried out in parallel by a purchaser system, a merchant system, an anonymous payment system and a third party payment provider system in accordance with an embodiment of the invention.

FIG. 4 illustrates a simplified example of an interactive merchant web page comprising offered items according to an embodiment of the invention.

FIG. 5 illustrates a simplified example of an interactive web page of an anonymous payment system for receiving payment information from a purchaser according to an embodiment of the invention.

FIG. 6 illustrates a simplified example of an interactive web page provided by an anonymous payment system displaying payment confirmation and a system generated sign on information on a purchaser display according to an embodiment of the invention.

FIG. 7 illustrates a simplified example of an interactive web page provided to a purchaser system by a merchant system enabling a purchaser to enter sign on information for accessing a purchased item according to an embodiment of the invention.

FIG. 8 illustrates a simplified example of a web page providing a purchased item for display on a purchaser display system according to an embodiment of the invention.

FIG. 9 is a block diagram illustrating a system for making anonymous online purchases wherein a merchant system originates anonymous sign on information according to an alternative embodiment of the invention.

FIG. 10 is a flowchart illustrating steps of methods carried out in parallel by a purchaser system, a merchant system, an anonymous payment system and a third party payment provider system in accordance with an embodiment of the invention wherein a merchant system originates anonymous sign on information.

FIG. 11 is a block diagram illustrating a system for making anonymous online purchases wherein a purchaser system originates anonymous sign on information and wherein the anonymous sign on information is provided to an anonymous payment system according to an embodiment of the invention.

FIG. 12 is a flowchart illustrating steps of methods carried out in parallel by a purchaser system, a merchant system, an anonymous payment system and a third party payment provider system in accordance with an embodiment of the invention wherein a purchaser system originates anonymous sign on information and wherein the anonymous sign on information is provided to an anonymous payment system according to an embodiment of the invention.

FIG. 13 illustrates a simplified example of an interactive web page provided by an anonymous payment system and displayed on a purchaser system for receiving payment information from a purchaser, and further illustrating a web page enabling a purchaser to choose anonymous sign on information according to an embodiment of the invention.

FIG. 14 illustrates a simplified example of an interactive web page provided by an anonymous payment system and displayed on a purchaser system for confirming payment by a purchaser, and further confirming anonymous sign information chosen by the purchaser on information according to an embodiment of the invention.

FIG. 15 is a block diagram illustrating a system for making anonymous online purchases wherein a purchaser originates anonymous sign on information and wherein the anonymous sign on information is provided to merchant system according to an embodiment of the invention.

FIG. 16 is a flowchart illustrating steps of methods carried out in parallel by a purchaser system, a merchant system, an anonymous payment system and a third party payment provider system in accordance with an embodiment of the invention wherein a purchaser system originates anonymous sign on information and wherein the anonymous sign on information is provided to a merchant system according to an embodiment of the invention.

FIG. 17 illustrates a simplified example of an interactive merchant web page comprising offered items as displayed on a purchaser system according to an embodiment of the invention wherein a purchaser is enabled to choose anonymous sign on information and wherein the anonymous sign on information is communicated to a merchant system.

FIG. 18 illustrates a simplified example of an interactive web page provided by an anonymous payment system and displayed on a purchaser system for receiving payment information from a purchaser.

FIG. 19 is a block diagram illustrating a system for making anonymous online purchases wherein a purchaser originates anonymous sign on information and wherein the anonymous sign on information is provided to merchant system according to an embodiment of the invention.

FIG. 20 is a flowchart illustrating steps of methods carried out in parallel by a purchaser system, a merchant system, an anonymous payment system and a third party payment provider system in accordance with an embodiment of the invention wherein a purchaser system originates anonymous sign on information and wherein the anonymous sign on information is provided to a merchant system according to an embodiment of the invention.

FIG. 22 is a block diagram illustrating an anonymous login information management system implemented by an anonymous payment system according to an embodiment of the invention.

### DETAILED DESCRIPTION OF THE INVENTION

In accordance with the present invention, there are provided herein methods and systems that facilitate the anonymous purchase of online content by purchasers, securely and conveniently, without the need to share credit card, email or other personal information with an on line merchant. Purchaser anonymity is preserved by purchasing online content, goods or services indirectly through an anonymous payment provider.

The payment system and method of the invention operates to effect anonymous purchases over the Internet. Broadly described, a purchaser indicates his or her intent to purchase online content at a merchant website. An anonymous payment provider purchases the content from the merchant. The anonymous service provider then resells access to the purchaser, thereby acting as a proxy for the purchaser in the transaction to preserve the purchaser's anonymity with respect to the merchant.

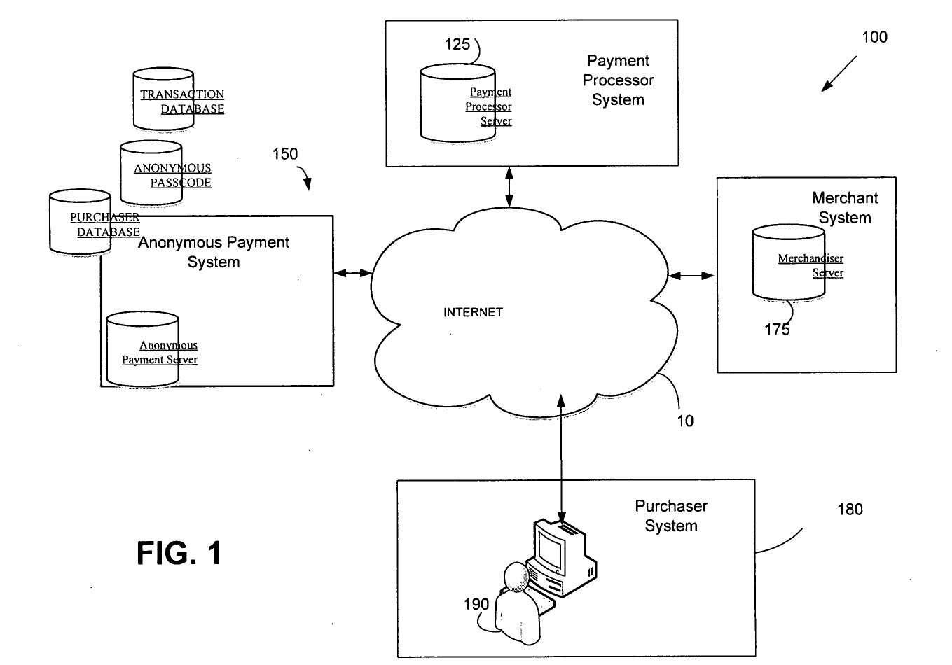

### FIG. 1 High Level Block Diagram

FIG. 1 is a block diagram illustrating a network suitable for implementing an anonymous payment provider system according to an embodiment of the invention. System 100 is seen to include a merchant system 175, an anonymous payment system 150, a payment processing system 125 and a purchaser's system 180. In its simplest form purchaser's system 135 includes conventional computing system components such as a user interface, operating system and software, communications interface and other standard components and features as are known in the art. It will be understood by the reader that essentially limitless numbers of purchaser's systems 135 are contemplated by the present invention. Numerous system variations including multi-processor systems, distributed data processing systems, server-based computing systems, notebook-based computing systems, mainframe-based computer systems and others are suitable for use in implementing systems 150, 125, 175 and 180.

The system components are seen to communicate through an appropriate communications medium 10, for example comprising a cellular telephone communications system, a public or private network such as the Internet, and/or others as will now be apparent to the reader. The systems 125,150 and 175 and purchaser system 180 are communicatively coupled via communication network 10. System 100 is configured to enable a purchaser 190 to access a merchant website for the purpose of viewing online content and purchasing goods or services for download or access.

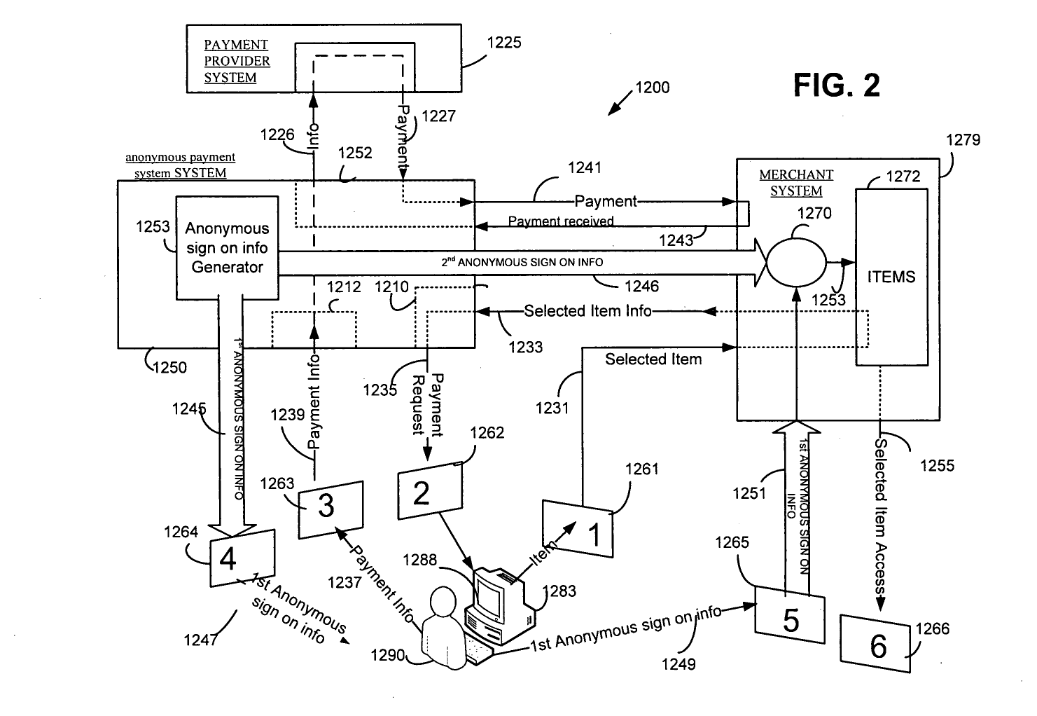

### FIG. 2 Detailed Block Diagram Example 1

FIG. 2 is a block diagram illustrating a system for making anonymous online purchases according to an embodiment of the invention wherein an anonymous payment system 1250 originates anonymous sign on information that enables a purchaser 1290 to remain anonymous to a merchant system 1279 when making a purchase from merchant 1279. A system of the invention comprises an anonymous payment system 1250 configured for communication with a merchant system 1279, a purchaser system 1283 and to a payment provider system 1225.

For purposes of this specification a “Merchant” is any entity that offers an item for sale over the Internet, for example, via an Internet website. An “item” refers to website content such as information, data, multimedia materials and the like. An item is offered to a purchaser by displaying a representation of the item to the purchaser. The term “item” also refers to any tangible good offered for sale via an Internet web site. A “merchant system” is a system configured to offer items for sale by providing interactive web pages to purchasers browsing the internet. The interactive web pages indicate the items for sale and other information about the items for sale. The interactive web pages are configured for display to a purchaser on a display device of a purchaser computer system. For example, the interactive web pages are displayed to a purchaser in response to a purchaser browsing or searching the World Wide Web.

Examples of “items” comprising tangible goods include, but are not limited to goods such as CDs, DVDs and purchaser electronics items, items of clothing, items of food, personal items, health care items to name but a few. Any tangible good capable of sale via the internet comprises an “item” for purposes of this specification. Likewise any intangible good, product or information accessible to a viewer or listener via the internet comprises an “item” for purposes of this specification. The term “item” also refers to a membership, for example, in an internet based club, organization or other website. The term “item” also refers to a subscription to access information available via the internet.

FIG. 2 illustrates a network 1200 suitable for implementing a system 1250 for enabling a buyer 1290 to make anonymous purchases from an on-line merchant according to an embodiment of the invention. In typical on-line sales systems a merchant system 1279 is configured to communicate with at least one purchaser computer system to offer at least one item for sale to a purchaser 1290. Typically at least one item is offered for sale by providing an interactive web page 1261 to purchaser computer system 1283. A display device 1288 is coupled to purchaser computer system 1283 for display of the interactive web page 1261 and thus, the items offered for sale.

The interactive web page 1261 typically displays an image or text representing at least one item offered for sale to purchaser 1290. In some cases a menu of items is provided and displayed to purchaser 1290. Purchaser 1290 selects an item for purchase using a mouse, keyboard, trackball or other suitable input device to indicate at least one item to be purchased. In response to the purchaser indicating an item for purchase, purchaser system 1283 transmits a message 1231 from the purchaser's system 1283 to the merchant's system 1279. The message 1231 includes information relating to the item selected by purchaser 1290 for purchase.

In one embodiment of the invention anonymous payment system 1250 stores a merchant URL for each merchant associated with anonymous payment system 1250. Anonymous payment system 1250 submits an HTTPS POST to merchant system 1279 to “get transaction information” including the merchant ID and merchant transaction ID parameters. The response to the “get transaction information” includes the relevant information about the purchaser's selected item. Anonymous system 1250 further stores a merchant system 1279 URL for system 1250 to submit an HTTPS POST to “confirm payment” including the merchant ID and merchant Transaction ID parameters along with system 1250 transaction ID parameter and a success/failure indication of the purchaser's use of anonymous payment system.

Merchant system 1279 is configured for communication with purchaser system 1283 and anonymous payment system 1250 via the internet. In response to receiving the information indicating the at least one item selected by purchaser 1290 for purchase, merchant system 1279 transmits a message 1233 including information about the at least one selected item to system 1250. According to some embodiments of the invention message 1233 comprises additional information about at least one item selected for purchase by purchaser 1290. Additional information may include for example, a SKU number or other product identifier, quantity of the items purchased, time and date of items purchased, etc.

Regardless of where anonymous sign on information originates, system 1250 comprises means, for example a communication port, configured for communication with a merchant system 1279 for receiving price information from merchant system 1279 about an item selected for purchase by a purchaser 1290.

System 1250 further comprises means for receiving payment of the price of at least one item selected for purchase by purchaser 1290. Examples of payment provider systems suitable for use in connection with the system of the invention include, but are not limited to, credit card companies, banks and other financial institutions. Such provider systems are typically configured to effect electronic payments for purchases made by their customers using, for example, a credit, debit, gift, or other account debit instrument issued to the customer by the financial institution. In one embodiment of the invention a communications port 1252 of system 1250 is configured for communication with a payment provider system 1225.

In some embodiments of the invention purchaser 1290 is provided with a request for payment for at least one item selected for purchase by purchaser 1290. In one embodiment of the invention the request provides a price to be paid for the selected item. In one embodiment of the invention the request is provided by system 1250. Regardless of the source of the request an interactive web page 1262 is provided to purchaser 1290 to convey the request and enable purchaser 1290 to respond to the request. For example, the interactive web page 1262 provides information about the price of the selected item and also enables purchaser 1290 to provide payment information 1237 to respond to the request for payment. The purchaser's payment information 1237 is provided to system 1250 via a message 1239 transmitted from purchaser system 1283 to system 1250.

In one embodiment of the invention payment information comprising message 1239 comprises credit card information for payment of the purchase price. However, the invention is not limited to credit cards as payment mechanisms. Other payment means include debit cards, gift cards, electronic checks, (automated clearing house) ACH transactions are suitable, to name but a few. Regardless of payment means, personal identifying information comprising payment information 1237 is communicated to system 1250. This payment information is not communicated to merchant system 1279.

Payment information 1237 includes, for example, information identifying the purchaser 1290 as the payment requestor, purchaser 1290 account identifying information, a demand for payment and other information related to purchaser 1290 and the purchaser's account from which payment for the selected item will be made. The payment information 1237 about an item selected for purchase is communicated from purchaser system 283 to system 1250, for example, by an electronic message 1239. A communications port 1212 of system 1250 receives message 1239 comprising the payment information.

System 1250 is configured to communicate with payment provider system 1225 to provide the payment information receives by system 1250 from purchaser system 1283. For example, system 1250 provides a message 1226 to payment provider system 1225. Message 1226 includes payment information derived from message 1239. In response to receiving message 1226, provider system 1225 effects payment to system 1250 for the at least one item selected for purchase by purchaser 1290. To confirm payment has been effected to system 1250 payment system 1225 provides a message 1227 to system 1250 related to the payment. System 1250 in turn provides a message 1241 to merchant system 1279 effecting payment by system 1250 to merchant 1279 for the at least one item purchased by purchaser 1290. In that manner system 1250 is enabled to receive payment of the price of the selected item from the purchaser. Therefore, payment may subsequently be made by system 1250 to merchant 1279 for the at least one selected item via message 1241 without providing personal information associated with purchaser 1290 in message 1241.

System 1250 further comprises means 1253 for providing first anonymous sign on information to purchaser system 1288 for display to purchaser 1290 on display means 288. The first anonymous sign on information is provided by generator 1253 in response to system 1250 receiving message 1227 from payment provider system 1225 indicating that payment of the price of the selected item has been satisfactorily effected. In one embodiment of the invention satisfactory payment is considered effected when system 1250 receives message 1227 from payment provider system indicating payment to system 250 was effected.

In an alternative embodiment of the invention satisfactory payment is considered effected when system 1250 receives confirmation from merchant system 1279 that payment has been received by merchant system 1279, as for example, via message 1243. Regardless of the means by which satisfactory payment is effected, after satisfactory payment is effected, the first anonymous sign on information is made available to purchaser 1290. In one embodiment of the invention first anonymous sign on information is made available to purchaser 1290 before payment is satisfactorily effected. However, in that case, first anonymous sign on information is not usable by purchaser 1290 to sign on to merchant site 1279 until payment has been satisfactorily effected.

After satisfactory payment is effected purchaser 1290 is enabled to provide the first anonymous sign on information to merchant site 1279 to access at least one purchased item. In one embodiment of the invention first anonymous sign on information is provided from purchaser system 1283 to merchant system 1279 via message 1251 after purchaser system 1283 receives the first anonymous sign on information from system 1250. Message 1251 is generated in response to interaction of purchaser 1290 with interactive web page 1265 to provide the first anonymous sign on information to merchant system 1279.

Merchant system 1279 compares the first anonymous sign on information it receives from purchaser 1290 in message 1251 to second sign on information related to purchased items. In one embodiment of the invention the first sign on information is used to identify the item purchased by purchaser 1290. This is accomplished in one embodiment of the invention by merchant system 1279 matching the first anonymous sign on information to corresponding second sign on information. Second sign on information is originated by merchant system 1279 in one embodiment of the invention. In an alternative embodiment of the invention second sign on information is originated by system 1250. Regardless of the originator of second sign on information, merchant system 1279 compares first sign on information to second sign on information in order to provide purchaser 1290 access to at least one item he/she purchased.

In one embodiment of the invention the first sign on information is used to verify that the purchaser 1290 generating message 1251 corresponds to the purchaser 1290 who had previously generated message 1231 indicating an item selected for purchase. In that manner merchant system 1279 is enabled to provide a purchased item to a purchaser 1290 who has paid for the item, without merchant system 1279 having received personal information associated with purchaser 1290.

In one example embodiment of the invention anonymous sign on information generator 1253 automatically generates first anonymous sign on information and corresponding second anonymous sign on information. In that case, first anonymous sign on information is provided to purchaser system 1283 and corresponding second anonymous sign on information is provided to merchant system 1279. In one example embodiment of the invention the automatically generated anonymous sign on information comprises a username and password. However, other types of sign on information are possible and the invention is not limited to sign on information comprising usernames and/or passwords. Any form of sign on information enabling purchaser 1290 to sign on to merchant system 1279 to access a purchased item in accordance with the various embodiments of the invention are suitable for use in the invention.

In one embodiment of the system 1250 enables purchaser 1290 to choose the first anonymous sign on information. System 1250 then provides second anonymous sign on information corresponding to the purchaser-chosen first anonymous sign on information to merchant system 1279. Merchant system 1279 will refer to the second anonymous sign on information when purchaser 1290 uses first anonymous sign on information to access purchased content on merchant system 1279.

System 1250 according to an embodiment of the invention further comprises means for providing the payment received by system 1250 to merchant system 1279. In one embodiment of the invention system 1250 includes a communications port configured to communicate with merchant system 1279 to provide message 1241 comprising information related to payment of the price of at least one selected item to merchant system 1279. Significantly, the information in message 1241 lacks personal information that would reveal the identity of purchaser 1290. In that manner payment is provided to merchant system 1279 without identifying purchaser 1290.

Merchant system 1279 does not receive information identifying the purchaser of a purchased item. In order for purchaser 1290 to access a purchased item purchaser 1290 provides the first anonymous sign on information obtained during the purchaser's interaction with system 1250, for example in message 1245, to merchant system 1279. Merchant system 1279 compares the first anonymous sign on information from purchaser 1290 with second anonymous sign on information. If the comparison indicates a correspondence between first anonymous sign on information and a second anonymous sign on information merchant system 1279 provides access to the purchased item to purchaser 1290 in response to purchaser 1290 providing the first anonymous sign on information to merchant system 1279. Purchaser 1290 remains anonymous to merchant 1279.

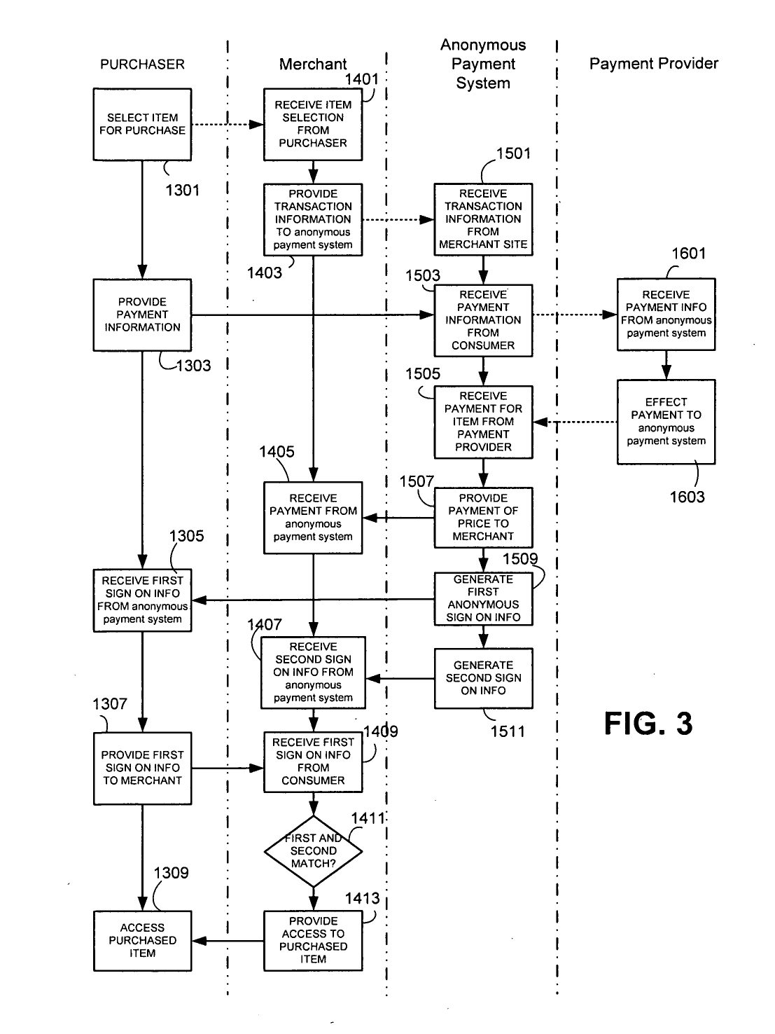

### FIG. 3 Flowchart Example 1—Anonymous Payment System Method and Merchant Method

FIG. 3 is a flowchart illustrating steps of methods carried out in parallel by a purchaser system, a merchant system, an anonymous payment system and a third party payment provider system in accordance with an embodiment of the invention

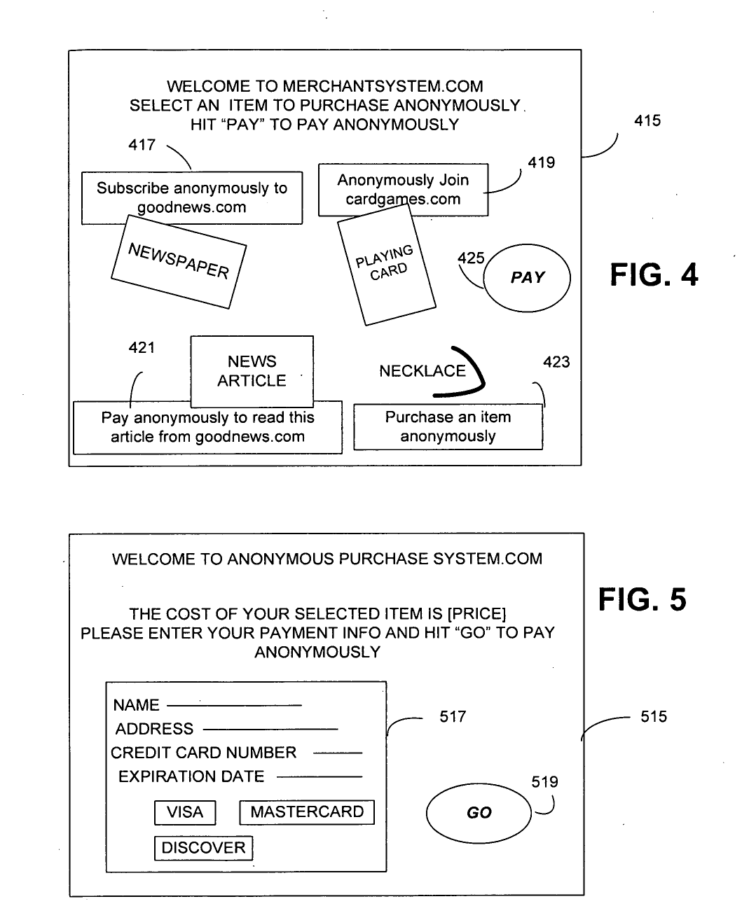

According to step 1301 a purchaser navigates the World Wide Web to view web pages provided by merchant systems. An example of a merchant system web page configured for use with systems and methods of the invention is illustrated in FIG. 4 at 415. The purchaser selects at least one item, for example at least one of items 417, 419, 421 and 423 for anonymous purchase from merchant system 1279. It will be recognized upon reading the description herein that various alternative configurations for web page 415 are possible. For example in one variation a merchant displays an interactive web page including items for selection and a single optional “purchase anonymously” button. In that case, after selection of at least one item a purchaser would activate the “purchase anonymously” to initiate an anonymous purchase.

As a result of the purchaser indicating at least one item for anonymous purchase merchant system 1279 receives the item selection indication as indicated at 1401. At step 1403 item information is provided to anonymous payment system 1250. Table 1 provides example item information provided at step 1403. In this specification, the term item is used synonymously with the term “offer”. The term offer used in Table 1 is synonymous with “item”. Further, for purposes of this specification the term “site” refers to a web site as well as to the system providing the web site.

TABLE 1
Offer Information

| Parameter | FL | Description | Comments |
|---|---|---|---|
| merchant_id | 10 | Identifies the Merchant | Unique id assigned by |
| | | | Anonymous payment system |
| | | | to the Merchant |
| merchant_transaction_id | 255 | Identifies this Merchant transaction | Unique id assigned by |
| | | | Merchant for this transaction |
| status | 1 | 1 = success (transaction information included) | |
| | | 2 = failure (see error_detail) | |
| error_detail | * | Detailed error message, (only valid when status = 2) - one of: | |
| | | Request did not originate from Anonymous payment system | |
| | | merchant_id did not match this merchant | |
| | | merchant_transaction_id not recognized | |
| | | Transaction already completed | |
| offer_id | 16 | Unique offer id per merchant | Assigned by Merchant |
| offer_name | 255 | Name of the offer | Assigned by Merchant |
| offer_type | 1 | 0 = One time charges | 1 = Recurring |
| | | | charges (not this case) |
| offer_time | 3 | Time length of the offer | 0 - if offer_type = |
| | | | 0; otherwise length of time |
| | | | of the recurring offer |
| offer_time_units | 1 | 1 = Minutes | Required if offer_time is not 0; |
| | | 2 = Hours | defines the units for “offer_time” |
| | | 3 = Days | |
| | | 4 = Weeks | |
| | | 5 = Months | |
| price | 10 | Offer Price | e.g., “10.95” for $10.95 |
| purchaser_login | 20 | Purchaser's login username for | |
| | | Merchant website | |
| purchaser_password | 20 | Purchaser's password for Merchant website | |
| site | 255 | Offer “belongs” to this site | Merchant reporting is site based, |
| | | | so offer should “belong” to site |
| affiliate | 10 | Identifies the affiliate, if any, via which | Unique id assigned by the Merchant |
| | | the purchase was initiated | to identify their affiliate |

In addition, when a purchaser initiates an anonymous purchase a hyperlink is activated to open a new web browser window at a URL associated with anonymous system 1250. For example in an example embodiment of the invention, a hyperlink to example URL: https://www.anonymous.com/engine/anonymous_cash is activated.

In response to activation of the hyperlink of anonymous payment system 1250, system 1250 provides an interactive web page enabling a purchaser to provide payment information by which payment for at least one purchased item will be effected. An example interactive web page enabling a purchaser to provide payment information is illustrated in FIG. 5 at 515. At step 1303 purchaser system 1283 provides payment information to anonymous payment system 1250. As indicated in FIG. 5 payment information 517 includes information such as name, address and credit card information. It is important to note payment information is provided by purchaser system to anonymous payment system 1250. This payment information is not provided to merchant system 1279.

At step 1503, anonymous system 1250 receives payment information from purchaser system 1283. Anonymous payment system 1283 analyzes the information to determine a payment source, such as a credit card, bank card, or checking account associated with the purchaser. Anonymous system 1250 provides the payment information to a payment provider system 1225 (illustrated in FIG. 2) for the payment source. At step 1601 payment provider system 1225 receives provides the payment information. Payment provider system 1225 effects payment to anonymous system 1250 as indicated at step 1603. At step 1505 anonymous payment system 1250 receives an indication that payment will be effected from payment system 1225.

At step 1507 anonymous payment system 1250 provides an indication of payment by anonymous system 1250 to merchant system 1279 for the at least one purchased item. Merchant system 1279 receives the indication of payment at step 1405. Table 2 provides an example of a message by which payment is indicated for a transaction effecting an anonymous purchase of an item.

TABLE 2
Confirm Payment

| Parameter | FL | Description | Comments |
|---|---|---|---|
| merchant_id | 10 | Identifies the Merchant | Unique id assigned by Anonymous |
| | | | payment system to the Merchant |
| merchant_transaction_id | 255 | Identifies this | Unique id assigned by Merchant for this |
| | | Merchant transaction | transaction |
| anonymous payment | 255 | Identifies this Anonymous | Unique id assigned by Anonymous |
| system_transaction_id | | payment system payment | payment system for this payment |
| status | 1 | 1 = success (funds reserved) | |
| | | 2 = failure (insufficient funds) | |

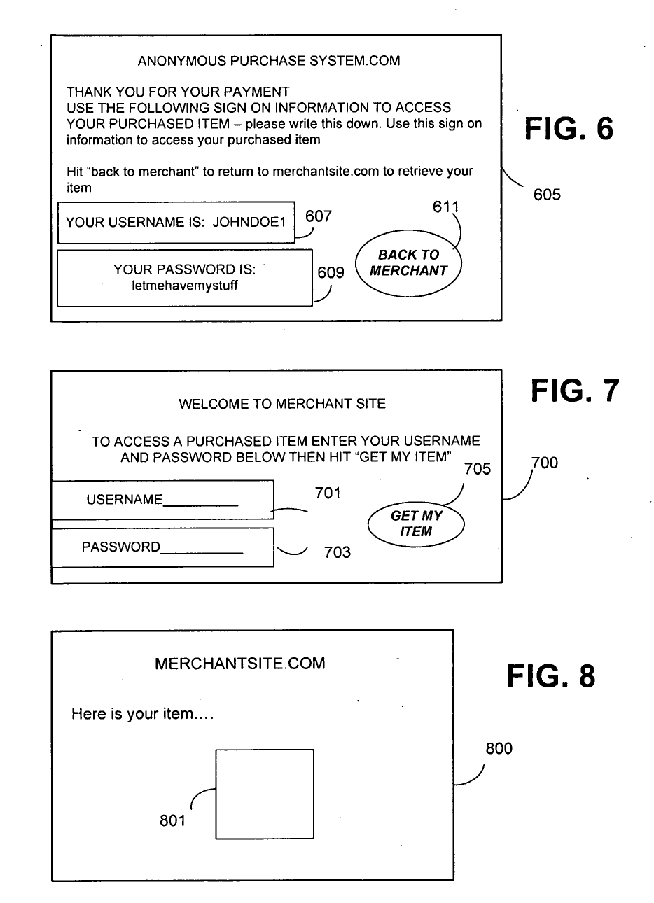

At step 1509 anonymous payment system 1250 generates first anonymous sign on information. In an example embodiment of the invention, first anonymous sign on information comprises a username and password. However, the invention is not limited to any particular format for first anonymous sign on information. At step 1305 the first anonymous sign on information is received by purchaser system 1283 and displayed to purchaser 1290. An example web page provided by anonymous payment system 1250 for display to purchaser 1290 is illustrated in FIG. 6 at 605. As illustrated, an example of first anonymous sign on information comprising a username “JOHNDOE1” 607 and password “givememystuff” 609 is displayed to purchaser 1290.

At step 1509, anonymous payment system 1250 generates second anonymous sign on information and provides the second anonymous sign on information to purchaser system 1283. In one embodiment of the invention second anonymous sign on information is identical to first anonymous sign on information. In alternative embodiments of the invention first and second anonymous sign on information need not be identical. As long as first and second sign on information can be correlated, for example, by means of a look up table, key or code second sign on information may take a different form or representation than first sign on information. At step 1307, merchant system 1407 receives second sign on information from anonymous payment system 1250.

Web page 605 illustrated in FIG. 6 also includes an interactive icon, e.g., at 611 enabling purchaser 1290 to be directed from anonymous system 1250 to merchant system 1279. Upon activation of the icon 705, merchant system 1279 provides an interactive web page enabling purchaser 1279 to enter the first anonymous sign on information received in step 1305 in order to access a purchased item. FIG. 7 illustrates an example interactive web page 700 enabling a purchaser to enter first anonymous sign on information 701,703 to sign on to merchant system 1279. At step 1307, purchaser 1290 enters the first anonymous sign on information 607, 609 provided in the previous step by entering the username and password in fields 701 and 703 of interactive web page 700.

At step 1409, merchant system 1279 receives first anonymous sign on information from purchaser system 1283. At step 1411 first and second sign on information are compared to determine if they are correlated. If the first and second anonymous sign on information are correlated, i.e., they match, merchant system 1279 enables the purchaser to access the purchased item as indicated at step 1413. At that time, purchaser 1309 may access the purchased item as indicated at step 1309. FIG. 8 illustrates an example web page 800 displaying purchased content 801 on a display of a purchaser system. Purchasing a site membership

### Purchasing an Item for Shipment:

In one embodiment of the invention a purchaser is enabled to anonymously purchase at least one item from a merchant for shipment to a shipment address. In that embodiment, merchant system 1279 provides anonymous payment system 1250 with information related to a fully populated “shopping cart” and information about shipping. Information about shipping includes, for example, shipping method, name and shipping address, shipping costs and taxes. In one embodiment of the invention merchant system 1279 receives the purchaser's shipping address from purchaser system 1283. Merchant system 1279 calculates the costs of shipping and tax associated with the purchased items and the shipping address. Therefore information about total price of purchased items, including shipping and tax, is provided to anonymous communication system 1250 by merchant system 1279.

In a variation of the invention, merchant system 1279 provides anonymous payment system 1250 with a fully populated shopping cart and passes information about various shipping options to anonymous payment system 1250. Anonymous payment system 1250 is provided with the purchaser's shipping information, for example address, contact information and desired shipping method. Anonymous purchasing system 1250 processes the information and provides related information to merchant system 1279, for example via a predetermined URL in order to obtain a final purchase amount. Merchant system 1279 then communicates the shipping and tax information to anonymous payment system 1250, and anonymous payment system 1250 subsequently displays a total cost of the purchased items, including shipping and taxes, to purchaser 1290.

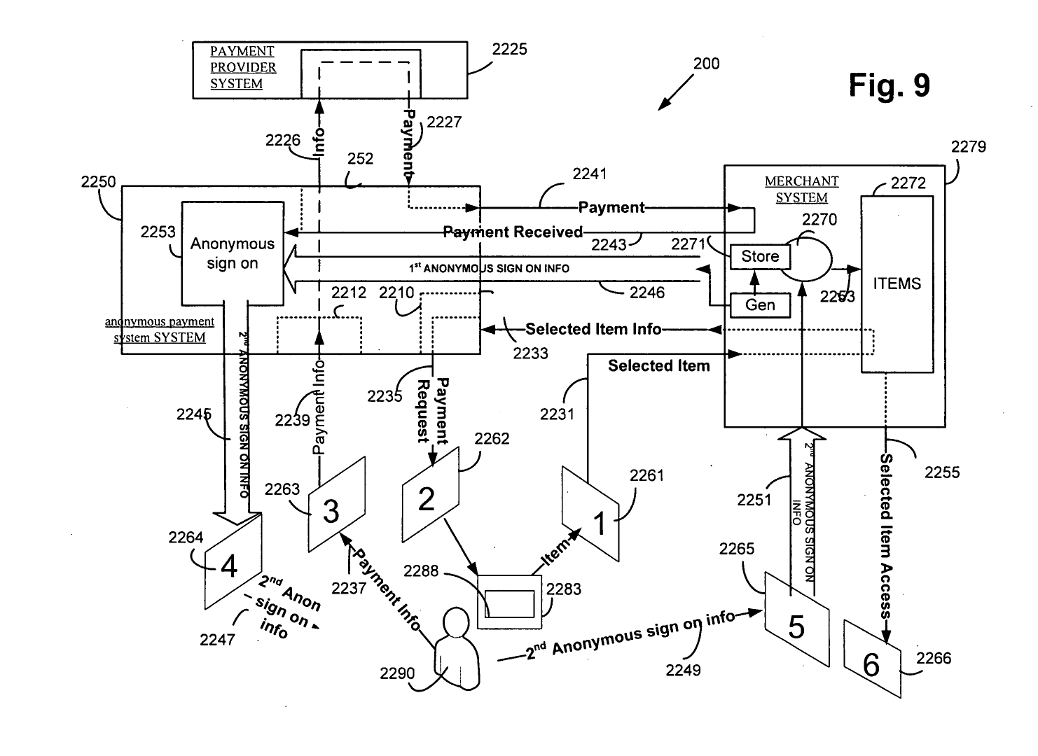

### FIG. 9 Detailed Block Diagram Example 2

FIG. 9 is a block diagram illustrating a network 2200 suitable for implementing an anonymous payment system 2250 for enabling anonymous online purchases from an on-line merchant system which originates anonymous sign on information according to an alternative embodiment of the invention. The network illustrated in FIG. 2200 comprises a plurality of computer systems configured for communication over the Internet.

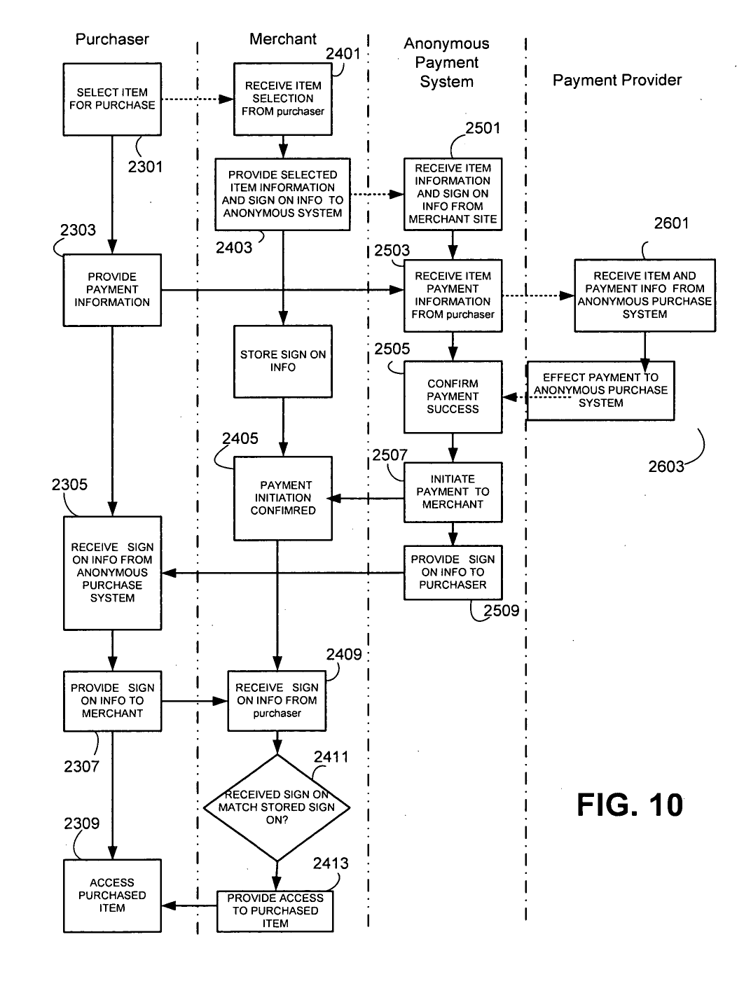

In typical on-line sales systems a merchant system 2279 is configured to communicate with at least one purchaser computer system to offer at least one item for sale to a purchaser 2290. Typically at least one item is offered for sale by providing an interactive web page 2261 (See label 1 in FIG. 10) to purchaser computer system 2283. A display device 2288 is coupled to purchaser computer system 2283 for display of the interactive web page 2261.

The interactive web page 2261 typically displays, to purchaser 2290, an image or text representing at least one item offered for sale by merchant system 2279. In some cases a menu of items is provided and displayed to purchaser 2290. Purchaser 2290 selects an item for purchase using a mouse, keyboard, trackball or other suitable input device to indicate at least one item to be purchased. In response to the purchaser indicating an item for purchase, purchaser system 2283 transmits a message 2231 for a selected item from purchaser system 2283 to merchant system 1079. The message 2231 includes, in addition to item identification, additional information relating to the item selected by the purchaser 2290.

Merchant system 2279 is configured for communication with anonymous payment system 2250 via the internet 10. In response to receiving message 2231 at merchant system 2279, merchant system 2279 transmits a message 2233 including information about the price of at least one selected item to anonymous payment system 2250. According to some embodiments of the invention message 2233 further comprises additional information about at least one item selected for purchase by purchaser 2290. The additional information may include for example, a SKU number or other product identifier, quantity of the items purchased, time and date of items purchased, etc.

Anonymous payment system 2250 comprises means, for example a communication port 2210, configured for communication with a merchant system 2279 for receiving message 2233 from merchant system 2279. In response to receiving message 2233 at anonymous payment system 2250, anonymous payment system 2250 issues a payment request message 2235 comprising a request for payment for the at least one item selected for purchase by purchaser 2290 at step 1. In one embodiment of the invention the payment request message 2235 includes a price to be paid for the selected item. An interactive web page 2262 is provided to purchaser 2290 to convey the payment request message 2235 from anonymous payment system 2250 and enable purchaser 2290 to respond to the request.

Anonymous Payment System 2250 further comprises means for receiving payment from purchaser 2290, via payment provider system 2225, for the price of at least one item selected for purchase by purchaser 2290. Examples of payment provider systems suitable for use in connection with the system of the invention include, but are not limited to, credit card companies, banks and other financial institutions. Such payment provider systems are typically configured to effect electronic payments for purchases made by their customers using, for example, a credit, debit, gift, or other account debit instrument issued to the customer by the financial institution.

For example, the interactive web page 2263 provides information about the price of the selected item to enable purchaser 2290 to provide payment information 2237 to respond to the request for payment. The purchaser's payment information 2237 is provided to anonymous payment system 2250 via a payment information message 2239 transmitted from purchaser system 2283 to anonymous payment system 2250.

In one embodiment of the invention payment information (communicated via message 2239) comprises credit card information for payment of the purchase price. However, the invention is not limited to credit cards as payment mechanisms. Other payment means include debit cards, gift cards, electronic checks, (automated clearing house) ACH transactions are suitable, to name but a few. Regardless of payment means, personal identifying information comprising payment information 2237 is communicated to anonymous payment system 2250.

Payment information 2237 includes, for example, information identifying the purchaser 2290 as the payment requestor, purchaser 2290 account identifying information, a demand for payment and other information related to purchaser 2290 and the purchaser's account from which payment for the selected item will be made. A communications port 2212 of anonymous payment system 2250 receives payment information message 2239 comprising the payment information.

Anonymous Payment System 2250 is configured to communicate with payment provider system 2225 to provide the payment information received by anonymous payment system 2250 from purchaser system 2283. For example, anonymous payment system 2250 provides a second payment information message 2226 to payment provider system 2225. Second payment information message 2226 includes payment information derived from payment information message 2239, received from purchaser 2290.

In response to receiving the second payment information message 2226 at provider system 2225, provider system 2225 effects payment to anonymous payment system 2250 for the at least one item selected for purchase by purchaser 2290. To confirm payment has been effected to anonymous payment system 2250, payment system 2225 provides a primary payment confirmation message 2227 to anonymous payment system 2250. Anonymous Payment System 2250 in turn provides a secondary payment confirmation message 2241 to merchant system 2279 confirming initiation of payment by anonymous payment system 2250 to merchant 2279 for the at least one item purchased by purchaser 2290. By receiving the payment effected message 2241 at anonymous payment system 2250, anonymous payment system 2250 is enabled to receive payment of the price of the selected item from the purchaser. Therefore, payment may subsequently be made by anonymous payment system 2250 to merchant 2279 for the at least one selected item via payment confirmation message 2241 without providing personal information associated with purchaser 2290.

Anonymous payment System 2250 further comprises means 2253 for providing first anonymous sign on information to purchaser system 2283 for display to purchaser 2290 on display means 2288. The first anonymous sign on information is provided by generator 2253 of anonymous payment system 2250 in response to anonymous payment system 2250 receiving primary payment confirmation message 2227 from payment provider system 2225 indicating that payment of the price of the selected item has been confirmed.

In one embodiment of the invention payment is considered confirmed when anonymous payment system 2250 receives primary payment confirmation message 2227 from payment provider system indicating payment to anonymous payment system 2250 was effected. In an alternative embodiment of the invention satisfactory payment is considered effected when anonymous payment system 2250 receives confirmation from merchant system 2279 that payment has been received by merchant system 2279, as for example, via message 2243.

Regardless of the means by which payment is confirmed, subsequently, the first anonymous sign on information is made available to purchaser 2290. After satisfactory payment is effected purchaser 2290 is enabled to provide the first anonymous sign on information to merchant site 2279 to access at least one purchased item. In one embodiment of the invention first anonymous sign on information is provided from purchaser system 1083 to merchant system 2279 via message 2251 after purchaser system 2283 receives the first anonymous sign on information from anonymous payment system 2250. Message 2251 is generated in response to interaction of purchaser 2290 with interactive web page 2265 to provide the first anonymous sign on information to merchant system 2279

Merchant system 2279 compares the first anonymous sign on information it receives from purchaser 2290 in message 2251 to second sign on information generated by Merchant system 2279 stored in memory 2271 of Merchant system 2279. In one embodiment of the invention the first sign on information is cross referenced to the item purchased by purchaser 2290. When purchaser 2290 signs on after payment through anonymous system 2250 merchant system 2279 compares the first anonymous sign on information to the stored corresponding second sign on information. Second sign on information is originated by merchant system 2279 in one embodiment of the invention. By cross referencing stored sign on information to items of a purchaser purchase, merchant system 2279 provides purchaser 1090 access to at least one item he/she purchased.

In one embodiment of the invention the first sign on information is used to verify that the purchaser 2290 generating message 2251 corresponds to the purchaser 2290 who had previously generated message 2231 indicating an item selected for purchase. In that manner merchant system 2279 is enabled to provide a purchased item to a purchaser 1090 who has paid for the item, without merchant system 2279 having received personal information associated with purchaser 2290.

In one example embodiment of the invention anonymous sign on information generator 2253 automatically generates first anonymous sign on information and corresponding second anonymous sign on information. In that case, first anonymous sign on information is provided to purchaser system 2283 and corresponding second anonymous sign on information is provided to merchant system 2279. In one example embodiment of the invention the automatically generated anonymous sign on information comprises a username and password. However, other types of sign on information are possible and the invention is not limited to sign on information comprising usernames and/or passwords. Any form of sign on information enabling purchaser 2290 to sign on to merchant system 2279 to access a purchased item in accordance with the various embodiments of the invention are suitable for use in the invention.

In one embodiment of the anonymous payment system 2250 enables purchaser 2290 to choose the first anonymous sign on information. Anonymous payment System 2250 then provides second anonymous sign on information corresponding to the purchaser-chosen first anonymous sign on information to merchant system 2279. Merchant system 2279 will refer to the second anonymous sign on information when purchaser 2290 uses first anonymous sign on information to access purchased content on merchant system 2279.

Anonymous payment System 2250 according to an embodiment of the invention further comprises means for providing the payment received by anonymous payment system 2250 to merchant system 2279. In one embodiment of the invention anonymous payment system 2250 includes a communications port configured to communicate with Merchant system 2279 to provide message 2241 comprising information related to payment of the price of at least one selected item to merchant system 2279. Significantly, the information in message 2241 lacks personal information that would reveal the identity of purchaser 2290. In that manner payment is provided to merchant system 2279 without identifying purchaser 2290.

Merchant system 2279 does not receive information identifying the purchaser of a purchased item. In order for purchaser 2290 to access a purchased item purchaser 2290 provides the first anonymous sign on information obtained during the purchaser's interaction with anonymous payment system 2250, for example in message 2245, to merchant system 2279. Merchant system 2279 compares the first anonymous sign on information from purchaser 2290 with second anonymous sign on information. If the comparison indicates a correspondence between first anonymous sign on information and a second anonymous sign on information merchant system 2279 provides access to the purchased item to purchaser 2290 in response to purchaser 2290 providing the first anonymous sign on information to merchant system 2279. Purchaser 2290 remains anonymous to merchant 2279.

### FIG. 10 Flowchart Example 2

FIG. 10 is a flowchart illustrating steps of methods carried out in parallel by a purchaser system, a merchant system, an anonymous payment system and a third party payment provider system in accordance with an embodiment of the invention wherein a merchant system originates anonymous sign on information.

According to step 2301 a purchaser navigates the World Wide Web to view web pages provided by merchant systems. An example of a merchant system web page configured for use with systems and methods of the invention is illustrated in FIG. 4 at 415. The purchaser selects at least one item, for example at least one of items 417, 419, 421 and 423 for anonymous purchase from merchant system 2279. It will be recognized upon reading the description herein that various alternative configurations for web page 415 are possible. For example in one variation a merchant displays an interactive web page including items for selection and a single optional “purchase anonymously” button. In that case, after selection of at least one item a purchaser would activate the “purchase anonymously” to initiate an anonymous purchase.

As a result of the purchaser indicating at least one item for anonymous purchase merchant system 2279 receives the item selection indication as indicated at 2401. In addition, when a purchaser initiates an anonymous purchase a hyperlink is activated to open a new web browser window at a URL associated with anonymous system 2250. For example in an example embodiment of the invention, a hyperlink to example URL: https://www.anonymous.com/engine/anonymous_cash is activated.

In response to activation of the hyperlink of anonymous payment system 2250, system 2250 provides an interactive web page enabling a purchaser to provide payment information by which payment for at least one purchased item will be effected. An example interactive web page enabling a purchaser to provide payment information is illustrated in FIG. 5 at 515. At step 2303 purchaser system 2283 provides payment information to anonymous payment system 2250. As indicated in FIG. 5 payment information 517 includes information such as name, address and credit card information. It is important to note payment information is provided by purchaser system to anonymous payment system 2250. This payment information is not provided to merchant system 2279.

At step 2503 anonymous system 2250 receives payment information from purchaser system 2283. Anonymous payment system 2283 analyzes the information to determine a payment source, such as a credit card, bank card, or checking account associated with the purchaser. Anonymous system 2250 provides the payment information to a payment provider system 2225 (illustrated in FIG. 2) for the payment source. At step 2601 payment provider system 2225 receives provides the payment information. Payment provider system 2225 effects payment to anonymous system 2250 as indicated at step 2603. At step 2505 anonymous payment system 2250 receives an indication that payment will be effected from payment system 2225.

At step 2507 anonymous payment system 2250 provides an indication of payment by anonymous system 2250 to merchant system 279 for the at least one purchased item. Merchant system 279 receives the indication of payment at step 2405.

At step 2509 anonymous payment system 2250 generates first anonymous sign on information. In an example embodiment of the invention, first anonymous sign on information comprises a username and password. However, the invention is not limited to any particular format for first anonymous sign on information. At step 2305 the first anonymous sign on information is received by purchaser system 2283 and displayed to purchaser 2290. An example web page provided by anonymous payment system 2250 for display to purchaser 2290 is illustrated in FIG. 6 at 605. As illustrated at 605 an example of first anonymous sign on information comprising a username “JOHNDOE1” 607 and password “givememystuff” 609 is displayed to purchaser 2290.

At step 2509, anonymous payment system 2250 generates second anonymous sign on information and provides the second anonymous sign on information to purchaser system 2283. In one embodiment of the invention second anonymous sign on information is identical to first anonymous sign on information. In alternative embodiments of the invention first and second anonymous sign on information need not be identical. As long as first and second sign on information can be correlated, for example, by means of a look up table, key or code second sign on information may take a different form or representation than first sign on information. At step 2307, merchant system 2279 receives second sign on information from anonymous payment system 2250.

Web page 605 illustrated in FIG. 6 also includes an interactive icon 611 enabling purchaser 2290 to be directed to merchant system 2279. Upon activation of the icon 611, merchant system 2279 provides an interactive web page enabling purchaser 2290 to enter the first anonymous sign on information received in step 2305 in order to access a purchased item. FIG. 7 illustrates an example interactive web page 700 enabling a purchaser to enter first anonymous sign on information 701, 703 to sign on to merchant system 2279. At step 2307, purchaser 2290 enters the first anonymous sign on information 607, 609 provided in the previous step by entering the username and password in fields 701 and 703 of interactive web page 700.

At step 2409, merchant system 2279 receives first anonymous sign on information from purchaser system 2283. At step 2411 first and second sign on information are compared to determine if they are correlated. If the first and second anonymous sign on information are correlated, i.e., they match, merchant system 2279 enables the purchaser to access the purchased item as indicated at step 2413. At that time, purchaser 2290 may access the purchased item as indicated at step 2309.

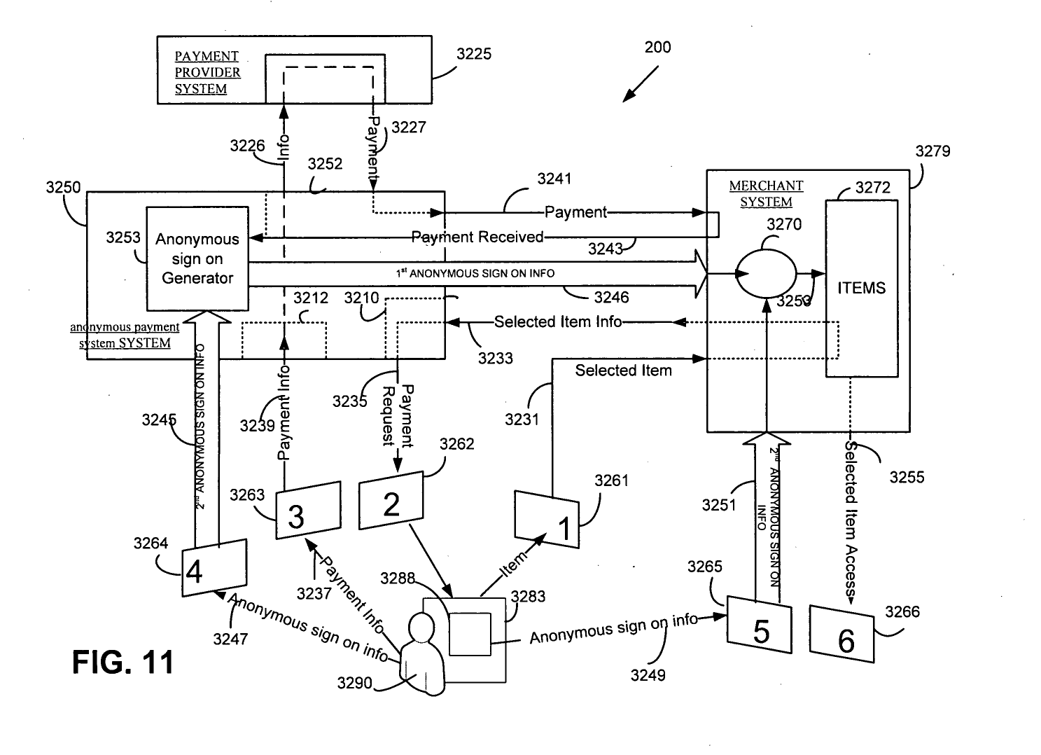

### FIG. 11 Detailed Block Diagram Example 3

FIG. 11 is a block diagram illustrating a system for making anonymous online purchases wherein a purchaser system originates anonymous sign on information and wherein the anonymous sign on information is provided to an anonymous payment system according to an embodiment of the invention. The network illustrated in FIG. 11 comprises a plurality of computer systems configured for communication over the Internet.

### Items Offered for Sale

In typical on-line sales systems a merchant system 3279 is configured to communicate with at least one purchaser computer system to offer at least one item for sale to a purchaser 3290. Typically at least one item is offered for sale by providing an interactive web page to purchaser computer system 3283. A display device 3288 is coupled to purchaser computer system 3283 for display of the interactive web page 3261.

The interactive web page 3261 typically displays, to purchaser 3290, an image or text representing at least one item offered for sale by merchant system 3279. In some cases a menu of items is provided and displayed to purchaser 3290. Purchaser 3290 selects an item for purchase using a mouse, keyboard, trackball or other suitable input device to indicate at least one item to be purchased. In response to the purchaser indicating an item for purchase, purchaser system 3283 transmits a message 3231 for a selected item from purchaser system 3283 to merchant system 3279. The message 3231 includes in addition to item identification, additional information relating to the item selected by the purchaser 3290.

Merchant system 3279 is configured for communication with anonymous payment system 3250 via the internet 12. In response to receiving message 3231 at merchant system 3279, merchant system 3279 transmits a message 3233 including information about the price of at least one selected item to anonymous payment system 3250. According to some embodiments of the invention message 3233 further comprises additional information about at least one item selected for purchase by purchaser 3290. The additional information may include for example, a SKU number or other product identifier, quantity of the items purchased, time and date of items purchased, etc.

Anonymous payment system 3250 comprises means, for example a communication port 3210, configured for communication with a merchant system 3279 for receiving message 3233 from merchant system 3279.

### Purchasing Items

In response to receiving message 3233 at anonymous payment system 3250, anonymous payment system 3250 issues a payment request message 3235 comprising a request for payment for the at least one item selected for purchase by purchaser 3290. In one embodiment of the invention the payment request message 3235 includes a price to be paid for the selected item. An interactive web page 3262 is provided to purchaser 3290 to enable purchaser 1290 to provide payment information in response to the payment request message 3235 from anonymous payment system 3250.

Anonymous Payment System 3250 further comprises means for receiving payment from purchaser 3290, via payment provider system 3225, for the price of at least one item selected for purchase by purchaser 3290. Examples of payment provider systems suitable for use in connection with the system of the invention include, but are not limited to, credit card companies, banks and other financial institutions. Such payment provider systems are typically configured to effect electronic payments for purchases made by their customers using, for example, a credit, debit, gift, or other account debit instrument issued to the customer by the financial institution.

For example, the interactive web page 3263 provides information about the price of the selected item. Purchaser 3290 is enabled to provide payment information 3237 to respond to the request for payment. The purchaser's payment information 3237 is provided to anonymous payment system 3250 via a payment information message 3239 transmitted from purchaser system 3283 to anonymous payment system 3250.

In one embodiment of the invention payment information (communicated via message 3239) comprises credit card information for payment of the purchase price. However, the invention is not limited to credit cards as payment mechanisms. Other payment means include debit cards, gift cards, electronic checks, (automated clearing house) ACH transactions are suitable, to name but a few. Regardless of payment means, personal identifying information comprising payment information 3237 is communicated to anonymous payment system 3250.

Payment information 3237 includes, for example, information identifying the purchaser 3290 as the payment requestor, purchaser 3290 account identifying information, a demand for payment and other information related to purchaser 3290 and the purchaser's account from which payment for the selected item will be made. A communications port 3212 of anonymous payment system 3250 receives payment information message 3239 comprising the payment information.

Anonymous Payment System 3250 is configured to communicate with payment provider system 3225 to provide the payment information received by anonymous payment system 3250 from purchaser system 3283. For example, anonymous payment system 3250 provides a second payment information message 3226 to payment provider system 3225. Second payment information message 3226 includes payment information derived from payment information message 3239, received from purchaser 3290.

In response to receiving the second payment information message 3226 at provider system 3225, provider system 3225 effects payment to anonymous payment system 3250 for the at least one item selected for purchase by purchaser 3290. To confirm payment has been effected to anonymous payment system 3250, payment system 3225 provides a primary payment confirmation message 3227 to anonymous payment system 3250. Anonymous Payment System 3250 in turn provides a secondary payment confirmation message 3241 to merchant system 3279 indicating initiation of payment by anonymous payment system 3250 to merchant 3279 for the at least one item purchased by purchaser 3290. By receiving the secondary payment confirmation message 3241 at anonymous payment system 3250, anonymous payment system 3250 is enabled to receive payment of the price of the selected item from the purchaser. Therefore, payment may subsequently be made by anonymous payment system 3250 to merchant 3279 for the at least one selected item via payment confirmation message 3241 without providing personal information associated with purchaser 3290 in payment confirmation message 3241.

Anonymous Payment System 3250 further comprises means 3253 for receiving first anonymous sign on information 3246 from purchaser 3290. Upon receiving the first anonymous sign on information 3246 from purchaser 3290, the anonymous sign on data repository 3253 stores the first sign on information 3246 until the payment received message 3243 is received from merchant system 3279. When payment received message 3243 is received by anonymous payment system 3250, first anonymous sign on information 3246 is provided to merchant system 3279.

Merchant system 3279 does not receive information identifying the purchaser of a purchased item. In order for purchaser 3290 to access a purchased item purchaser 3290 provides the same second anonymous sign on information she provided to anonymous payment system 3250. A comparing circuit 3270 of merchant system 3279 compares the first anonymous sign on information 3246 received from anonymous payment system 3250 with second anonymous sign on information 3251, received from purchaser 3290. If the comparison indicates a correspondence between first anonymous sign on information 3246 and second anonymous sign on information 3251, merchant system 3279 provides access to the purchased item to purchaser 3290. Purchaser 3290 remains anonymous to merchant 3279.

In one embodiment of the invention the first sign on information 3246 is cross referenced to the item purchased by purchaser 3290. By cross referencing stored sign on information to items of a purchaser purchase, merchant system 3279 provides purchaser 3290 access to at least one item purchaser 3290 has purchased.

In one embodiment of the invention first sign on information 3246 is compared to second sign on information 3251 to verify that purchaser 3290 has paid for the purchased items. In that manner merchant system 3279 is enabled to provide a purchased item to a purchaser 3290 who has paid for the item, without merchant system 3279 having received personal information from purchaser 3290.

In one example embodiment of the invention the automatically generated anonymous sign on information comprises a username and password. However, other types of sign on information are possible and the invention is not limited to sign on information comprising usernames and/or passwords. Any form of sign on information enabling purchaser 3290 to sign on to merchant system 3279 to access a purchased item in accordance with the various embodiments of the invention are suitable for use in the invention.

In the event merchant system 3270 successfully compares the first anonymous sign on information 3246 with the second anonymous sign on information 3251, access to the selected item is provided to purchaser 3290.

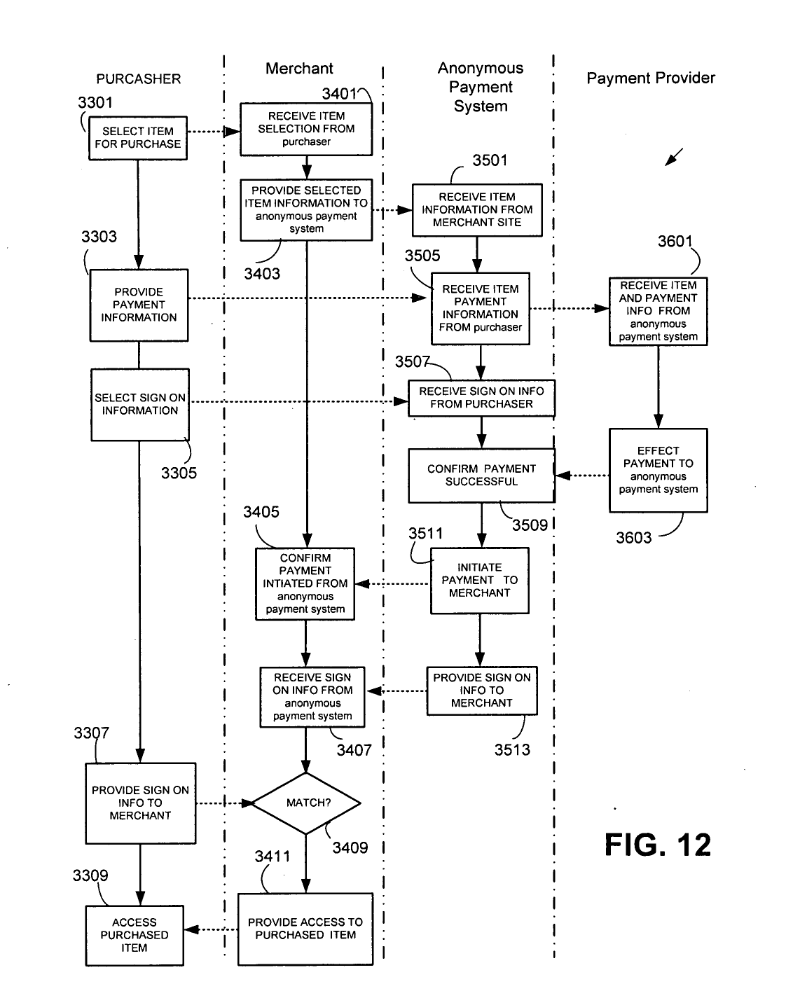

### FIG. 12 Flowchart Example 3

FIG. 12 is a flowchart illustrating steps of methods carried out in parallel by a purchaser system, a merchant system, an anonymous payment system and a third party payment provider system in accordance with an embodiment of the invention wherein a purchaser system originates anonymous sign on information and wherein the anonymous sign on information is provided to an anonymous payment system according to an embodiment of the invention.

According to step 3301 a purchaser navigates the World Wide Web to view web pages provided by merchant systems. An example of a merchant system web page configured for use with systems and methods of the invention is illustrated in FIG. 4 at 415. The purchaser selects at least one item, for example at least one of items 417, 419, 421 and 423 for anonymous purchase from merchant system 3279. It will be recognized upon reading the description herein that various alternative configurations for web page 415 are possible. For example in one variation a merchant displays an interactive web page including items for selection and a single optional “purchase anonymously” button. In that case, after selection of at least one item a purchaser would activate the “purchase anonymously” to initiate an anonymous purchase.

As a result of the purchaser indicating at least one item for anonymous purchase merchant system 3279 receives the item selection indication as indicated at 3401. In addition, when a purchaser initiates an anonymous purchase a hyperlink is activated to open a new web browser window at a URL associated with anonymous system 3250. For example in an example embodiment of the invention, a hyperlink to example URL: https://www.anonymous.com/engine/anonymous_cash is activated.

In response to activation of the hyperlink of anonymous payment system 3250, system 3250 provides an interactive web page enabling a purchaser to provide payment information by which payment for at least one purchased item will be effected. An example interactive web page enabling a purchaser to provide payment information is illustrated in FIG. 5 at 515. As indicated in FIG. 5 payment information 517 includes information such as name, address and credit card information. It is important to note payment information is provided by purchaser system to anonymous payment system 3250. This payment information is not provided to merchant system 3279.

At step 3503 anonymous system 3250 receives payment information from purchaser system 3283. Anonymous payment system 3283 analyzes the information to determine a payment source, such as a credit card, bank card, or checking account associated with the purchaser. Anonymous system 3250 provides the payment information to a payment provider system 3225 (illustrated in FIG. 3) for the payment source. At step 3601 payment provider system 3225 receives provides the payment information. Payment provider system 3225 effects payment to anonymous system 3250 as indicated at step 3603. At step 3505 anonymous payment system 3250 receives an indication that payment will be effected from payment system 3225.

At step 3507 anonymous payment system 3250 provides an indication of payment by anonymous system 3250 to merchant system 3279 for the at least one purchased item. Merchant system 3279 receives the indication of payment at step 3405.

At step 3509 anonymous payment system 3250 generates first anonymous sign on information. In an example embodiment of the invention, first anonymous sign on information comprises a username and password. However, the invention is not limited to any particular format for first anonymous sign on information. At step 3305 the first anonymous sign on information is received by purchaser system 3283 and displayed to purchaser 3290. An example web page provided by anonymous payment system 3250 for display to purchaser 3290 is illustrated in FIG. 7 at 1700. As illustrated at 1701 an example of first anonymous sign on information comprising a username “JOHNDOE1” and password “givememystuff” is displayed to purchaser 3290.

At step 3509, anonymous payment system 3250 generates second anonymous sign on information and provides the second anonymous sign on information to purchaser system 3283. In one embodiment of the invention second anonymous sign on information is identical to first anonymous sign on information. In alternative embodiments of the invention first and second anonymous sign on information need not be identical. As long as first and second sign on information can be correlated, for example, by means of a look up table, key or code second sign on information may take a different form or representation than first sign on information. At step 3307, merchant system 3407 receives second sign on information from anonymous payment system 3250.

Web page 1700 illustrated in FIG. 8 also includes an interactive icon enabling purchaser 3290 to be directed to merchant system 3279. Upon activation of the icon merchant system 3279 provides an interactive web page enabling purchaser 3279 to enter the first anonymous sign on information received in step 3305 in order to access a purchased item. FIG. 8 illustrates an example interactive web page 8800 enabling a purchaser to enter first anonymous sign on information to sign on to merchant system 279. At step 3307, purchaser 290 enters the first anonymous sign on information provided in the previous step by entering the username and password in fields 8803 and 8804 of interactive web page 8800.

At step 3409, merchant system 279 receives first anonymous sign on information from purchaser system 3283. At step 3411 first and second sign on information are compared to determine if they are correlated. If the first and second anonymous sign on information are correlated, i.e., they match, merchant system 3279 enables the purchaser to access the purchased item as indicated at step 3413. At that time, purchaser 3309 may access the purchased item as indicated at step 3309.

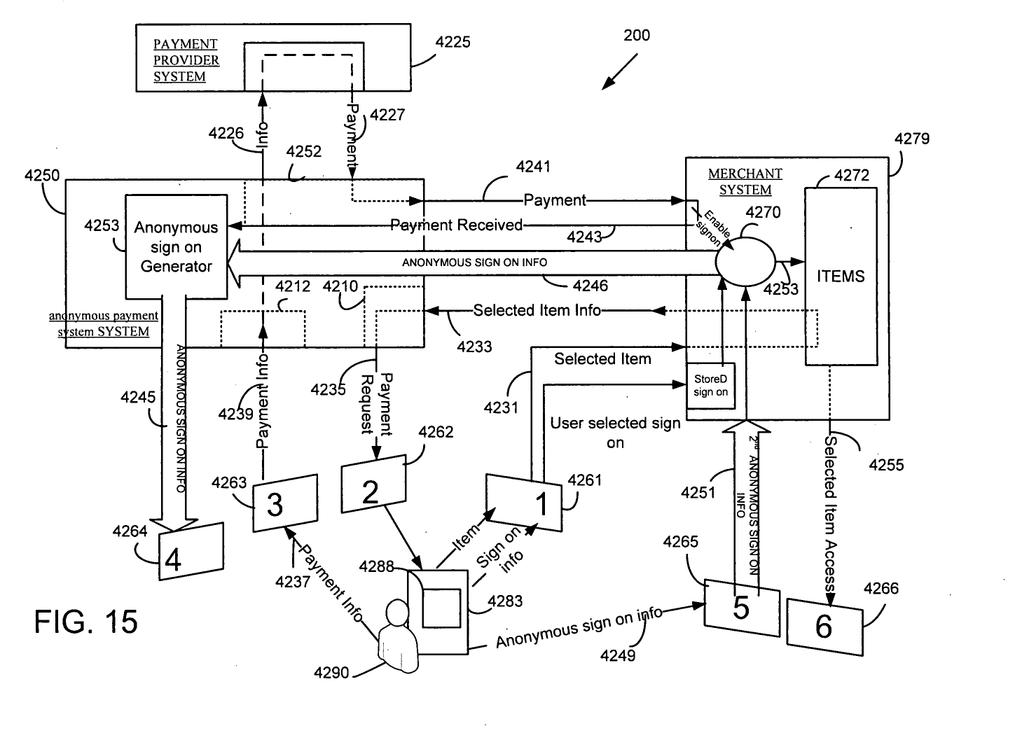

### FIG. 15 Detailed Block Diagram Example 4

FIG. 15 is a block diagram illustrating a network 4200 suitable for implementing an anonymous payment system 4250 for enabling anonymous online purchases from an on-line merchant system which originates anonymous sign on information according to an alternative embodiment of the invention. The network illustrated in FIG. 15 comprises a plurality of computer systems configured for communication over the Internet.

In typical on-line sales systems a merchant system 4279 is configured to communicate with at least one purchaser computer system to offer at least one item for sale to a purchaser 4290. Typically at least one item is offered for sale by providing an interactive web page 4261 (See label 1 in FIG. 18) to purchaser computer system 4283. A display device 4288 is coupled to purchaser computer system 4283 for display of the interactive web page 4261.

The interactive web page 4261 typically displays, to purchaser 4290, an image or text representing at least one item offered for sale by merchant system 4270. In some cases a menu of items is provided and displayed to purchaser 4290. Purchaser 4290 selects an item for purchase using a mouse, keyboard, trackball or other suitable input device to indicate at least one item to be purchased. In response to the purchaser indicating an item for purchase, purchaser system 4283 transmits a message 4231 for a selected item from purchaser system 4283 to merchant system 4279. The message 4231 includes, in addition to an item identification, additional information relating to the item selected by the purchaser 4290.

Purchaser 4290 further submits first anonymous sign on information which is generated by purchaser 4290 and transmitted from purchaser system 4283 to merchant system 4279. The first anonymous sign on information is temporarily stored at merchant system 4279. In addition to storing the sign on information, the information is forwarded from the merchant system 4279 to the anonymous sign on generator 4253 of the anonymous payment system 4250.

Merchant system 4279 is configured for communication with anonymous payment system 4250 via the internet 10 (See FIG. 1). In response to receiving message 4231 for a purchaser selected item at merchant system 4279, merchant system 4279 transmits a selected item information message 4233 to anonymous payment system 4250, the message 4233 including at least information about the price of at least one purchaser selected item. According to some embodiments of the invention, the message 4233 further comprises additional information about at least one item selected for purchase by purchaser 4290. The additional information may include for example, a SKU number or other product identifier, quantity of the items purchased, time and date of items purchased, etc.

Anonymous payment system 4250 comprises means, for example a communication port 4210, configured for communication with a merchant system 4279 for receiving message 4233 from merchant system 4279.

In response to receiving message 4233 at anonymous payment system 4250, anonymous payment system 4250 issues a payment request message 4235 to purchaser system 4283, the payment request message 4235 comprising a request for payment from purchaser 4290 for the at least one item selected for purchase by purchaser 4290 at step 1. In one embodiment of the invention the payment request message 4235 includes a price to be paid for the selected item. An interactive web page 4262 is provided to purchaser 4290 to convey the payment request message 4235 from anonymous payment system 4250 to enable purchaser 4290 to respond to the request.

Anonymous Payment System 4250 further comprises means for receiving payment from purchaser 4290, facilitated by payment provider system 4225, for the price of at least one item selected for purchase by purchaser 4290. Examples of payment provider systems suitable for use in connection with the system of the invention include, but are not limited to, credit card companies, banks and other financial institutions. Such payment provider systems are typically configured to effect electronic payments for purchases made by their customers using, for example, a credit, debit, gift, or other account debit instrument issued to the customer by the financial institution.

For example, the interactive web page 4263 provides information about the price of the selected item to enable purchaser 4290 to provide payment information 4237 to respond to the request for payment. The purchaser's payment information 4237 is provided to anonymous payment system 4250 via a payment information message 4239 transmitted from purchaser system 4283 to anonymous payment system 4250.

In one embodiment of the invention payment information 4237, is communicated via payment message 4239, comprises credit card information for payment of the purchase price. However, the invention is not limited to credit cards as payment mechanisms. Other payment means include debit cards, gift cards, electronic checks, (automated clearing house) ACH transactions are suitable, to name but a few. Regardless of payment means, personal identifying information comprising payment information 4239 is communicated to the payment provider system 4225, via the anonymous payment system 4250.

Payment information 4237 includes, for example, information identifying the purchaser 4290 as the payment requestor, purchaser 4290 account identifying information, a demand for payment and other information related to purchaser 4290 and the purchaser's account from which payment for the selected item will be made. A communications port 4212 of anonymous payment system 4250 receives payment information message 4239 comprising the payment information 4237.

Anonymous Payment System 4250 is configured to communicate with payment provider system 4225 to provide the payment information 4237 received from purchaser system 4290 via anonymous payment system 4250.

In response to receiving the second payment information message 4226 at provider system 4225, provider system 4225 effects payment to anonymous payment system 4250 for the at least one item selected for purchase by purchaser 4290. To confirm payment has been effected to anonymous payment system 4250, payment system 4225 provides a payment confirmation message 4227 to anonymous payment system 4250. Anonymous Payment System 4250 in turn provides a payment confirmation message 4241 to merchant system 4279 effecting payment by anonymous payment system 4250 to merchant 4279 for the at least one item purchased by purchaser 4290.

In response to receiving the payment confirmation message 4241 at merchant system 4279, the merchant system 4279 transmits a payment received message 4243 which enables anonymous payment system 4250 to receive payment of the price of the selected item from the purchaser 4290. Therefore, upon receiving payment of the price of the item from purchaser 4290 at anonymous payment system 4250, payment may subsequently be made by anonymous payment system 4250, on behalf of purchaser 4290, to merchant 4279 for the at least one selected item via payment confirmation message 4241 without providing personal information associated with purchaser 4290 in payment confirmation message 4241.

Merchant system 4279 provides anonymous sign on information 4246 to anonymous payment provider 4250 to be temporarily stored there. At this point, the stored anonymous sign on information 4246 is forwarded to purchaser system 4283. Purchaser 4290 transmits the second anonymous sign on information to merchant system 4270. For example, the second anonymous sign on information may be transmitted from purchaser system 4283 to merchant system 4270 in second anonymous sign on information message 4251. At merchant system 4279, comparator 4270 of merchant system 4279 compares the previously received and stored anonymous sign on information, received from purchaser system 4283 at step 1 with the recently received anonymous sign on information, received from the anonymous payment system 4250 at step 4. A comparison between the two can only occur when the comparator is enabled via “enable signal on”, sourced from payment provider system 4225, upon receiving payment confirmation. If the comparison results in a correspondence (e.g., match) between the first anonymous sign on information and the second anonymous sign on information, merchant system 4279 provides access to the purchased item to purchaser 1890. It is understood that purchaser 4290 remains anonymous to merchant 4279 in this process.

In one embodiment of the invention the first sign on information 4246 is cross referenced to the item purchased by purchaser 4290. By cross referencing stored sign on information to items of a purchaser purchase, merchant system 4279 provides purchaser 4290 access to at least one item, purchaser 4290 has purchased.

In one embodiment of the invention the first sign on information 4246 is used to verify that the purchaser 4290 generating message 4251 corresponds to the purchaser 4290 who had previously generated message 4231 indicating an item selected for purchase. In that manner merchant system 4279 is enabled to provide a purchased item to a purchaser 4290 who has paid for the item, without merchant system 4279 having received personal information from purchaser 4290.

In one example embodiment of the invention the automatically generated anonymous sign on information comprises a username and password. However, other types of sign on information are possible and the invention is not limited to sign on information comprising usernames and/or passwords. Any form of sign on information enabling purchaser 4290 to sign on to merchant system 4279 to access a purchased item in accordance with the various embodiments of the invention are suitable for use in the invention.

In the event comparator 4270 of merchant system 4270 successfully compares the first anonymous sign on information with the second anonymous sign on information, access to the selected item is provided to purchaser 4290. Access notification is provided from merchant system 4279 to purchaser system 4283 via access message 4255, viewable from GUI display 4266, provided to purchaser system 4283.

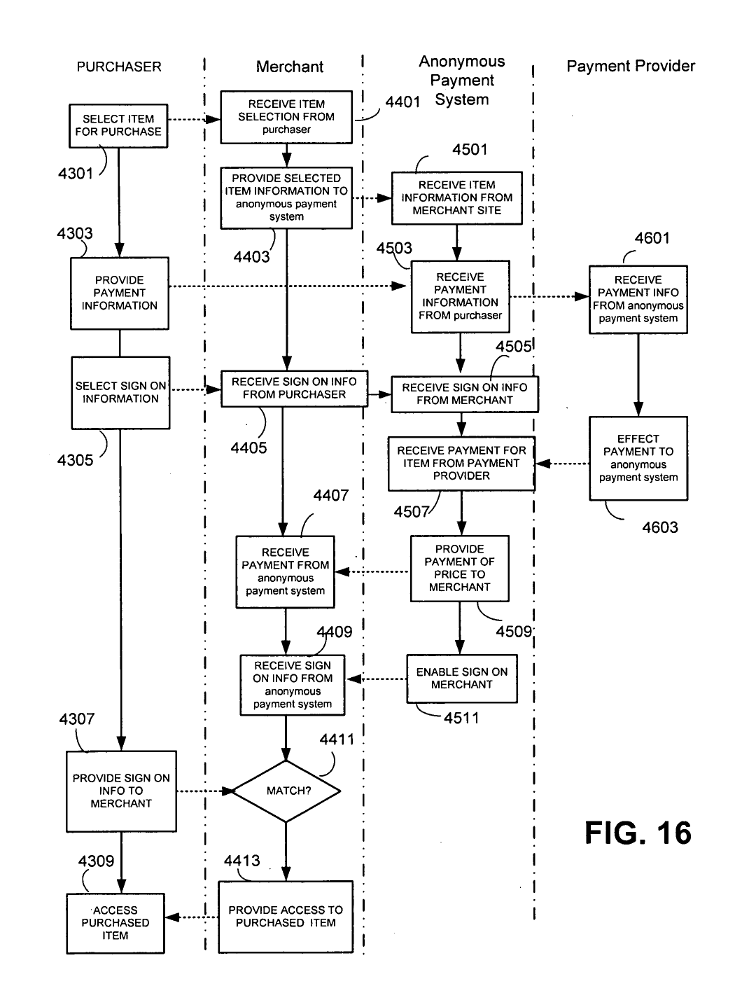

### FIG. 16 Flowchart Example 4

FIG. 16 is a flowchart illustrating steps of methods carried out in parallel by a purchaser system, a merchant system, an anonymous payment system and a third party payment provider system in accordance with an embodiment of the invention wherein a purchaser system originates anonymous sign on information and wherein the anonymous sign on information is provided to a merchant system according to an embodiment of the invention.

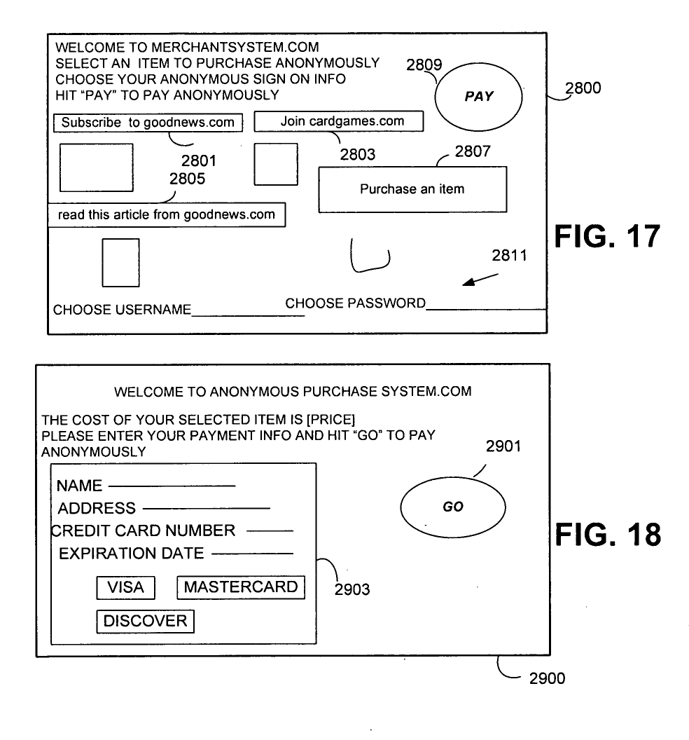

According to step 4301 a purchaser navigates the World Wide Web to view web pages provided by merchant systems. An example of a merchant system web page configured for use with systems and methods of the invention is illustrated in FIG. 17 at 2800. The purchaser selects at least one item, for example at least one of items 2801, 2803, 2805 and 2807 for anonymous purchase from merchant system 4279. It will be recognized upon reading the description herein that various alternative configurations for web page 2800 are possible. For example in one variation a merchant displays an interactive web page including items for selection and a single optional “purchase anonymously” button. In that case, after selection of at least one item a purchaser would activate the “purchase anonymously” to initiate an anonymous purchase.

As a result of the purchaser indicating at least one item for anonymous purchase, merchant system 4279 receives the item selection indication as indicated at 4401. Merchant system 4279 provides information about the selected item to anonymous purchase system 4250 as indicated at 4403. Anonymous payment system 4250 receives the item information from merchant system 4279 as indicated at 4501.

Web page 2800 further provides an interactive area 2811 to enable a purchaser to provide purchaser selected anonymous sign on information. Web page 2800 further provides an interactive icon enabling the purchaser system to provide the information about items to be purchased and purchaser chosen sign on information to merchant system 4279. Merchant system 4279 receives the information as indicated at 4401 and 4405. In turn, merchant system 4279 provides the information to anonymous payment system 4250 as indicated at 4403. Anonymous payment system 4250 receives item information at step 4501 and sign on information at step 4503.

When a purchaser initiates an anonymous purchase by activating icon 2809 a hyperlink is activated to open a web browser window at a URL associated with anonymous system 4250. For example in an example embodiment of the invention, a hyperlink to example URL: https://www.anonymous.com/engine/anonymous_cash is activated.

In response to activation of the hyperlink of anonymous payment system 4250, system 4250 provides an interactive web page enabling a purchaser to provide payment information by which payment for at least one purchased item will be effected as called for by step 4305. Anonymous payment system 4503 receives the payment information from purchaser system 4283 at step 4505.

An example interactive web page enabling a purchaser to provide payment information is illustrated in FIG. 18 at 2903. At step 4305 purchaser system 4283 provides payment information to anonymous payment system 4250 where it is received as indicated at step 4505. As indicated in FIG. 18 payment information 2903 includes information such as name, address and credit card information. It is important to note payment information is provided by purchaser system to anonymous payment system 4250. This payment information is not provided to merchant system 4279.

Anonymous payment system 4283 analyzes the payment information to determine a payment source, such as a credit card, bank card, or checking account associated with the purchaser. Anonymous system 4250 provides the payment information to a payment provider system 4225 (illustrated in FIG. 3) where it is received at step 4601 for payment. Payment provider system 4225 effects payment to anonymous system 4250 as indicated at step 4603. At step 4507 anonymous payment system 4250 receives an indication that payment will be effected from payment system 4225.

At step 4507 anonymous payment system 4250 receives an indication of payment. Anonymous system 4250 provides an indication to merchant system 4279 that payment will be made for the at least one purchased item as indicated at 4509. Merchant system 4279 receives the indication of payment at step 4407. Once merchant system 4279 receives indication that payment will be made merchant system 4279 enables purchaser 4290 to sign on to the merchant system to access the purchased item as indicated at 4409. In one embodiment of the invention merchant system 4279 provides anonymous sign on information to anonymous payment system 4250. Anonymous payment system 4250 provides a confirmation of the purchaser selected sign on information for display to the purchaser.

Purchaser 4290 provides the purchaser selected sign on information to merchant system 4279 at step 4307. At step 4411 merchant system 4279 compares the stored sign on information with the purchaser selected sign on information provided by the purchaser system at step 4307 to determine if they are correlated. If they are correlated, i.e., they match, merchant system 4279 enables the purchaser to access the purchased item as indicated at step 4413. At that time, purchaser 4309 may access the purchased item as indicated at step 4309.

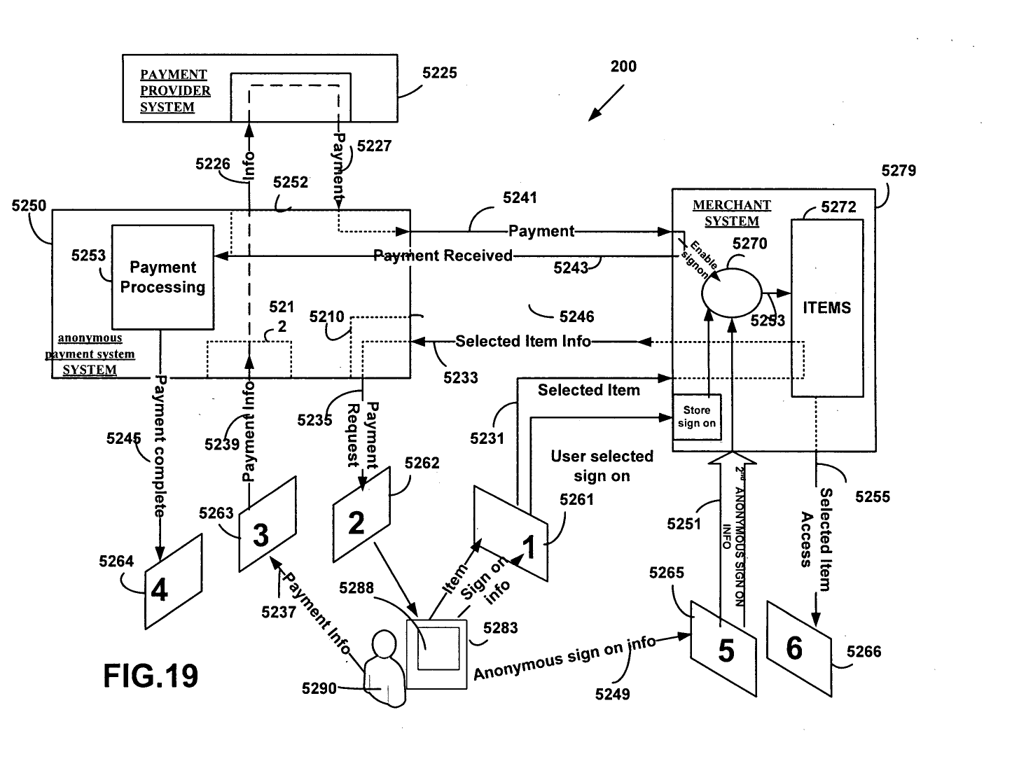

### FIG. 19 Detailed Block Diagram Example 5

FIG. 19 is a block diagram illustrating a system for making anonymous online purchases wherein a purchaser originates anonymous sign on information and wherein the anonymous sign on information is provided to merchant system according to an embodiment of the invention.

In typical on-line sales systems a merchant system 5279 is configured to communicate with at least one purchaser computer system to offer at least one item for sale to a purchaser 5290. Typically at least one item is offered for sale by providing an interactive web page 5261 (See label 1 in FIG. 24) to purchaser computer system 5283. A display device 5288 is coupled to purchaser computer system 5283 for display of the interactive web page 5261.

The interactive web page 5261 typically displays, to purchaser 5290, an image or text representing at least one item offered for sale by merchant system 5270. In some cases a menu of items is provided and displayed to purchaser 5290. Purchaser 5290 selects an item for purchase using a mouse, keyboard, trackball or other suitable input device to indicate at least one item to be purchased. In response to the purchaser indicating an item for purchase, purchaser system 5283 transmits a message 5231 for a selected item from purchaser system 5283 to merchant system 5279. The message 5231 includes in addition to an item identification, additional information relating to the item selected by the purchaser 5290.

Purchaser 5290 further submits first anonymous sign on information which is generated by purchaser 5290 and transmitted from purchaser system 5283 to merchant system 5279. The first anonymous sign on information is temporarily stored at merchant system 5279. In addition to storing the sign on information, the information is forwarded from the merchant system 5279 to the anonymous sign on generator 5253 of the anonymous payment system 5250.

Merchant system 5279 is configured for communication with anonymous payment system 5250 via the internet 10 (See FIG. 1). In response to receiving message 5231 for a purchaser selected item at merchant system 5279, merchant system 5279 transmits a selected item information message 5233 to anonymous payment system 5250, the message 5233 including at least information about the price of at least one purchaser selected item. According to some embodiments of the invention, the message 5233 further comprises additional information about at least one item selected for purchase by purchaser 5290. The additional information may include for example, a SKU number or other product identifier, quantity of the items purchased, time and date of items purchased, etc.

Anonymous payment system 5250 comprises means, for example a communication port 5210, configured for communication with a merchant system 5279 for receiving message 5233 from merchant system 5279.

In response to receiving message 5233 at anonymous payment system 2450, anonymous payment system 5250 issues a payment request message 5235 to purchaser system 5283, the payment request message 5235 comprising a request for payment from purchaser 5290 for the at least one item selected for purchase by purchaser 5290. In one embodiment of the invention the payment request message 5235 includes a price to be paid for the selected item. An interactive web page 5262 is provided to purchaser 5290 to convey the payment request message 5235 from anonymous payment system 5250 to enable purchaser 5290 to respond to the request.

Anonymous Payment System 5250 further comprises means for receiving payment from purchaser 5290, facilitated by payment provider system 5225, for the price of at least one item selected for purchase by purchaser 5290. Examples of payment provider systems suitable for use in connection with the system of the invention include, but are not limited to, credit card companies, banks and other financial institutions. Such payment provider systems are typically configured to effect electronic payments for purchases made by their customers using, for example, a credit, debit, gift, or other account debit instrument issued to the customer by the financial institution.

For example, the interactive web page 5263 provides information about the price of the selected item to enable purchaser 5290 to provide payment information 5237 to respond to the request for payment at step 3 (see payment request 2435). The purchaser's payment information 5237 is provided to anonymous payment system 5250 via a payment information message 5239 transmitted from purchaser system 5283 to anonymous payment system 5250.

In one embodiment of the invention payment information 5237, communicated via payment message 5239, comprises credit card information for payment of the purchase price. However, the invention is not limited to credit cards as payment mechanisms. Other payment means include debit cards, gift cards, electronic checks, (automated clearing house) ACH transactions are suitable, to name but a few. Regardless of payment means, personal identifying information comprising payment information 5237 is communicated to the payment provider system 5225, via the anonymous payment system 5250.

Payment information 5237 includes, for example, information identifying the purchaser 5290 as the payment requestor, purchaser 5290 account identifying information, a demand for payment and other information related to purchaser 5290 and the purchaser's account from which payment for the selected item will be made. A communications port 5212 of anonymous payment system 5250 receives payment information message 5239 comprising the payment information 5237.

Anonymous Payment System 5250 is configured to communicate with payment provider system 5225 to provide the payment information 5237 communicated via payment message 5239 and received from purchaser system 5290. Anonymous payment system 2450 provides a second payment information message 2426 to payment provider system 2425. Second payment information message 2426 includes payment information derived from payment information message 2439, received from purchaser 2490.

In response to receiving the second payment information message 5226 at provider system 5225, provider system 5225 effects payment to anonymous payment system 5250 for the at least one item selected for purchase by purchaser 5290. To confirm payment has been effected to anonymous payment system 5250, payment provider system 5225 provides a payment confirmation message 5227 to anonymous payment system 5250. Anonymous Payment System 5250 in turn provides a payment confirmation message 5241 to merchant system 5279 effecting payment by anonymous payment system 5250 to merchant 5279 for the at least one item purchased by purchaser 5290.

In response to receiving the payment confirmation message 5241 at merchant system 5279, the merchant system 5279 transmits a payment received message 5243 to a payment processing module 5253 of the anonymous payment system 5250 which enables anonymous payment system 2450 to receive payment of the price of the selected item from the purchaser 2490.

Anonymous payment system 5250 transmits a payment complete message 5245 to the purchaser 5290. FIG. 22 is a block diagram illustrating an example interactive web page informing a purchaser that payment is complete. An interactive icon 2981 enables the purchaser to return to the merchant's web site to access their purchased item.

Purchaser 5290 generates second anonymous sign on information 5249 to be transmitted to merchant system 5279. An interactive web page 5265 is provided to purchaser 5290 to enable purchaser 5290 to transmit second anonymous sign on information 5249. For example, the second anonymous sign on information may be transmitted from purchaser system 5283 to merchant system 5270 in second anonymous sign on information message 5251.

Comparator 5270 of merchant system 5279 compares the previously received and stored user provided anonymous sign on information (See step 1) with the second anonymous sign on information 5249. A comparison between the two inputs only occurs upon receiving an enable signal at the comparator (i.e., “enable signal on”), sourced from payment provider system 5225. The enable signal confirms that payment was received from purchaser 5290. If the comparison results in a correspondence (e.g., match) between the user selected anonymous sign on information and the second anonymous sign on information, merchant system 5279 provides access to the purchased item to purchaser 5290. It is understood that purchaser 5290 remains anonymous to merchant 5279 in this process.

In one embodiment of the invention the first sign on information 5246 is cross referenced to the item purchased by purchaser 5290. By cross referencing stored sign on information to items of a purchaser purchase, merchant system 5279 provides purchaser 5290 access to at least one item, purchaser 5290 has purchased.

In one embodiment of the invention the second anonymous sign on information is used to verify that the purchaser 5290 generating sign on message 5251 corresponds to the same purchaser 5290 who had previously generated message 5231 indicating an item selected for purchase. In that manner merchant system 5279 is enabled to provide a purchased item to a purchaser 5290 who has paid for the item, without merchant system 5279 having received personal information from purchaser 5290.

In one example embodiment of the invention the automatically generated anonymous sign on information comprises a username and password. However, other types of sign on information are possible and the invention is not limited to sign on information comprising usernames and/or passwords. Any form of sign on information enabling purchaser 5290 to sign on to merchant system 5279 to access a purchased item in accordance with the various embodiments of the invention are suitable for use in the invention.

In the event comparator 5270 of merchant system 5270 successfully compares the user selected anonymous sign on information with the second anonymous sign on information, access to the selected item is provided to purchaser 5290. Access notification is provided from merchant system 5279 to purchaser system 5283 via access message 5255, viewable from interactive web display 5266, provided to purchaser system 5283.

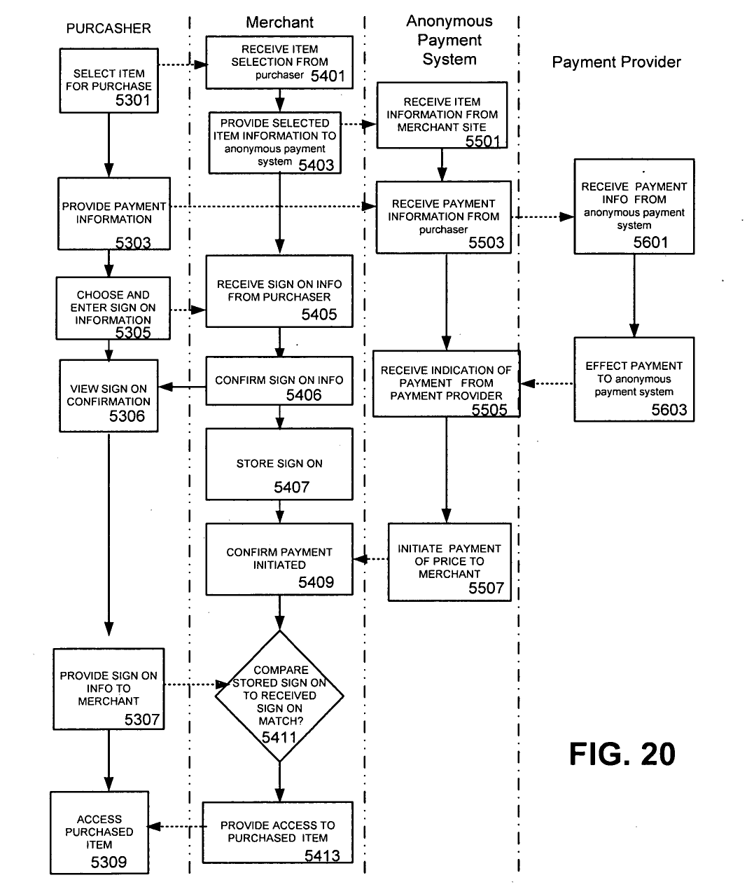

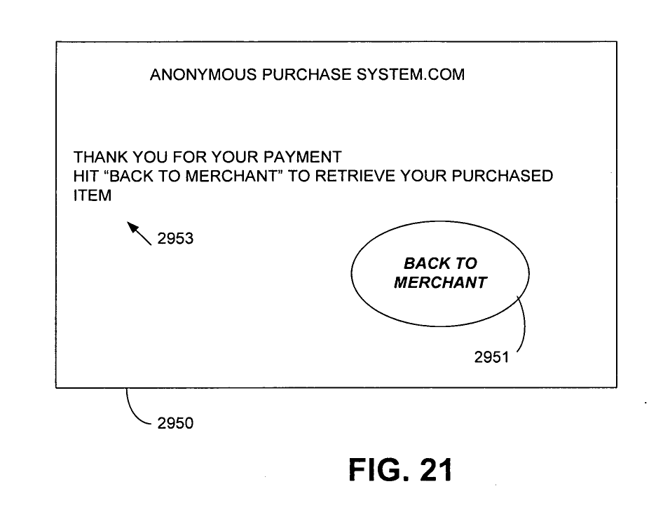

### FIG. 20 Flowchart Example 5

FIG. 20 is a flowchart illustrating steps of methods carried out in parallel by a purchaser system, a merchant system, an anonymous payment system and a payment provider system in accordance with an embodiment of the invention wherein a purchaser originates anonymous sign on information. The anonymous sign on information is provided to the merchant system according to an embodiment of the invention.

According to step 5301 a purchaser navigates the World Wide Web to view web pages provided by merchant systems. An example of a merchant system web page configured for use with systems and methods of the invention is illustrated in FIG. 4 at 415. The purchaser selects at least one item, for example at least one of items 417, 419, 421 and 423 for anonymous purchase from merchant system 5279.

As a result of the purchaser indicating at least one item for anonymous purchase merchant system 5279 receives the item selection indication as indicated at 5401. At step 5403 merchant system 5279 provides information about the selected item to anonymous payment system 5250 where it is received at step 5501. In addition to effecting item selection, when a purchaser initiates an anonymous purchase a hyperlink is activated to open a web browser window at a URL associated with anonymous system 5250. For example in an example embodiment of the invention, a hyperlink to example URL: https://www.anonymous.com/engine/anonymous_cash is activated.

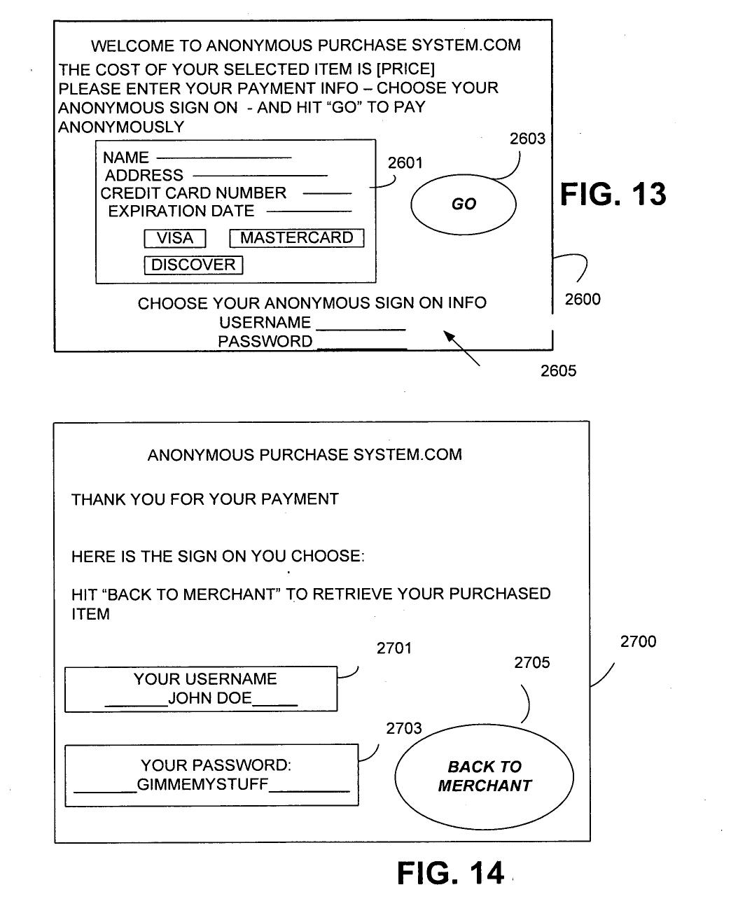

In response to activation of the hyperlink of anonymous payment system 5250, system 5250 provides an interactive web page enabling a purchaser to provide (at 5303), and anonymous payment system 5250 to receive (at 5503) payment information related to least one item selected for purchase. An example interactive web page 2600 enabling a purchaser to provide payment information 2601 is illustrated in FIG. 13.

At step 5303 purchaser system 5283 provides payment information to anonymous payment system 5250. As indicated in FIG. 13 payment information 2601 includes information such as name, address and credit card information. It is important to note payment information is provided by purchaser system to anonymous payment system 5250. This payment information is not provided to merchant system 5279.

At step 5503 anonymous system 5250 receives payment information from purchaser system 5283. Anonymous payment system 5250 analyzes the information to determine a payment source, such as a credit card, bank card, or checking account associated with the purchaser. Anonymous system 5250 provides the payment information to a payment provider system 5225 (illustrated in FIG. 2) for the payment source. At step 5601 payment provider system 5225 receives provides the payment information. Payment provider system 5225 effects payment to anonymous system 5250 as indicated at step 5603. At step 5505 anonymous payment system 5250 receives an indication of the status of the payment requested from payment system 5225.

If payment is successful, at step 5507 anonymous payment system 5250 provides an indication of payment by anonymous system 5250 to merchant system 5279 of a price for the at least one purchased item. Merchant system 5279 receives the indication of payment at step 5409.

At step 5305 purchaser 5290 chooses anonymous sign on information. In one embodiment of the invention an interactive portion 2605 of web page 2600 illustrated in FIG. 13 is configured to enable purchaser 5290 to input purchaser-chosen anonymous sign on information 2605. In an example embodiment of the invention anonymous sign on information 2605 comprises a username and password. However, the invention is not limited to any particular format for anonymous sign on information 2605.

At step 5405 the purchaser chosen anonymous sign on information is received by anonymous purchase system 5250. In one optional embodiment of the invention anonymous payment system 5250 provides a confirmation of the purchaser chosen sign on information for display to purchaser 5290 at step 5406. An example web page provided by anonymous payment system 5250 for display to purchaser 5290 is illustrated in FIG. 14 at 2701, 2703. As illustrated at 2701 an example confirmation message provided by anonymous payment system 5250 comprising a username “JOHNDOE” and password 2703 “givememystuff” is displayed to purchaser 5290. At step 5306 the purchaser is enabled to view the confirmation of his or her chosen sign on information.

As indicated at 5407 merchant system 5279 stores the purchaser-chosen anonymous sign on information. Web page 2700 illustrated in FIG. 14 also includes an interactive icon 2705 enabling purchaser 5290 to be directed to merchant system 5279. Upon activation of the icon 2705 merchant system 5279 provides an interactive web page enabling purchaser 5279 to enter the anonymous sign on information chosen in step 5305 in order to access a purchased item. FIG. 7 illustrates an example interactive web page 700 enabling a purchaser to provide purchaser-chosen anonymous sign on information to merchant system 5279. At step 5307, purchaser 5290 enters the purchaser-chosen sign on information, for example, a purchaser-chosen username and password in fields 701 and 703 of interactive web page 700.

At step 5411 stored sign on information is compared to the sign on information provided by purchaser 5490 determine if they are correlated. In this embodiment of the invention, even if anonymous sign on information is correlated, i.e., they match, merchant system 5279 will not enable the purchaser to access the purchased item unless payment confirmation is received according to step 5409. When payment is confirmed and if user sign on information is correlated, merchant system 5279 provides access to purchased items for purchaser 5390 as indicated at 5413. Purchaser 5290 is enabled to access the purchased item as indicated at step 5309.

### Anonymous Purchase Accounts

According to an embodiment of the invention an anonymous purchase system enables a purchaser to establish at least one access code corresponding to an anonymous payment account. An anonymous payment account is established, for example, during the course of making an anonymous purchase as described herein above. That is, a purchaser visits a merchant web site and selects an item for anonymous purchase from the merchant. In accordance with some of the embodiments of the invention described above, the purchaser is provided with anonymous account sign on information, e.g., a username and password in the process of making an anonymous purchase. Some embodiments of the invention further provide an access code for the user making the anonymous purchase. The access code is provided to the purchaser in addition to anonymous sign on information. In some optional embodiments of the invention both an access code and a personal identification number (PIN) are provided to the purchaser by an anonymous purchase system of the invention during the anonymous purchasing process.

An access code and, where provided, a PIN are associated with an account maintained on behalf of a purchaser by an anonymous purchase system configured in accordance with of one of the various embodiments of the invention described herein. The term “access code” therefore is occasionally used herein synonymously with the term “account” when referring to an account established for a purchaser in the process of effecting an anonymous purchase.

In one embodiment of the invention a purchaser is enabled to fund an account in a manner that maintains the purchaser's anonymity to those merchants from whom the purchaser will make anonymous purchases using the account. For example using various embodiments of the invention a purchaser is enabled to purchase an item comprising a subscription or membership, i.e., recurring access to content or services from an on line merchant. At the expiration of the subscription period a subscription or membership expires unless payment is effected for its renewal

Some embodiments of the invention enable a purchaser to anonymously subscribe to content provided by a merchant using an anonymous purchase account. For example a merchant sells subscriptions or memberships that enable access to online content or services. For continued access to a purchased subscription a purchaser establishes anonymous sign on information, for example a username and password. The purchaser receives an anonymous access code corresponding to an account maintained by the anonymous purchase system on behalf of the purchaser.

To use the account to make an anonymous purchase a purchaser selects an item, for example, a subscription for anonymous purchase from a merchant. An anonymous purchase web page is provided to the purchaser's system by anonymous purchase system 1250. The purchaser then enters his or her access code and, if applicable, PIN in appropriate fields of the web page. The purchaser subsequently clicks an interactive icon to submit the information to the anonymous purchase system.

The anonymous purchase system verifies the validity of the access code and PIN. The anonymous purchase system further confirms the account associated with the access code is enabled for the type of access sought and has a balance sufficient to consummate the purchase. Once the anonymous purchase system establishes the above, the purchaser is enabled to access the purchased subscription or membership.

According to one embodiment of the invention if a purchaser uses a credit card to make the initial subscription transaction and if the purchaser's account balance is insufficient to pay for subsequent re-bills, the anonymous purchase system will initiate a charge to the purchaser's credit card directly. In that manner a consumer automatically replenishes his or her anonymous purchase account.

### Balance Protection

According to one embodiment of the invention if funds are not sufficient, the anonymous payment system checks if the access code has automatic replenishment. Automatic replenishment is effected through an embodiment of the invention providing a balance protection feature. If an access code has a balance protection feature enabled the account corresponding to the access code will be replenished automatically. According to a balance protection method of the invention an overdraft of an anonymous account is automatically charged to a purchaser's credit card. In one embodiment of the invention a difference between a purchase price and the purchasers account balance is automatically charged to the purchaser's credit card.

If the access code does not have a balance protection feature, then anonymous system checks to determine if the access code was purchased using a credit card. If it was, then the anonymous system automatically obtains payment from a payment provider system in the amount of the next subscription renewal payment. In that manner an account is provided with funds sufficient to make the renewal payment.

A system for managing usernames and passwords is provided according to various embodiments of the invention. According to one embodiment of the invention the anonymous payment system maintains a record of all usernames and passwords associated with a purchaser's account. A purchaser is enabled to use his or her access code to view these records. Embodiments of the invention enable a purchaser to perform at least one of the following account management actions.

An embodiment of the invention enables a purchaser to terminate subscriptions by canceling a membership with a merchant site. In one embodiment of the invention a purchaser can provide the anonymous payment system with his or her access code and PIN to initiate a subscription termination using account management features provided by embodiments of the invention.

Embodiments of the account management features and functions of the invention provide account management features enabling a purchaser to view balances on the purchaser's anonymous accounts. Using the account management features of the invention a purchaser can enable a balance protection feature for the purchaser's accounts. Balances associated with an account are redeemable using the account management features of the invention.

In some cases a purchaser with more than one account will desire to combine the balance in one account with a balance in a different account. Embodiments of methods of the invention include steps of combining account balances. Other embodiments of the invention enable a purchaser to personalize the purchaser's PIN to better remember it in the future.

Table 3 provides a list of access codes corresponding to accounts of a purchaser. For each access code there is shown example functions available to a purchaser. For example a purchaser is enabled to manage PINs, view account balance, add funds to and account, combine funds in one account with funds in a different account and view purchase history associated with an account. It is important to note systems of the invention are configured such that only the purchaser may view this information.

TABLE 3

| | | Account | Add to Access | Purchase |
|---|---|---|---|---|
| Access Code | PIN | Balance | Code | History |
| XXXXXX12 | RESET LOST | $20.39 | ADD FUNDS | VIEW |
| | PERSONALIZE PIN | | COMBINE ACCES CODES | |
| XXXXXX54 | RESET LOST | $4.53 | ADD FUNDS | VIEW |
| | PERSONALIZE PIN | | COMBINE ACCES CODES | |
| XXXXXX86 | RESET LOST | $8.92 | ADD FUNDS | VIEW |
| | PERSONALIZE PIN | | COMBINE ACCES CODES | |

Table 4 provides an example listing of information provided by systems of the invention for viewing by a purchaser. For each website associated with an account (or access code) a purchaser is enabled to view the purchaser's username and password for each site, cost of subscription or access to each site, date of purchase of access to each site, and the billing method for each site.

TABLE 4
AC: 1234 5678 9995

| | | | | Billing |
|---|---|---|---|---|
| SITE | UN/PW | Cost | Purchase Date | Method |
| www.medinfo.com | USERNAME: John_doe | $9.95 | Jul. 4, 2006 | Monthly |
| | PASSWORD: VIEW | | | |
| www.autoclub.com | _USERNAME: John_doe | $9.95 | Aug. 4, 2006 | Monthly |
| | PASSWORD: VIEW | | | |
| www.consumers.com | USERNAME: John_doe | $.79 | Aug. 16, 2006 | One-time |
| | PASSWORD: VIEW | | | |

### Database Configuration

### First Database

Returning now to FIG. 1, anonymous payment system 150 comprises first second and third databases 151, 152 and 152. According to an embodiment of the invention first data base 151 is configured to store access codes (AC) and PIN codes. In one embodiment of the invention at least one of an AC and a PIN is provided to a purchaser upon purchasing a gift card for a predetermined funding amount. In one embodiment of the invention the AC and PIN are both secure and anonymous. That is, the access code and PIN allows any purchaser to use the gift card to buy and shop anonymously at any participating merchant site online or offline.

To implement this feature some embodiments of the invention comprise at least a first database configured to store information related to access codes and PINs. For example a first database stores internal identification codes, access codes, PINs, account creation dates, gift card balances and status information. This information is stored without association within the first database to an identifiable purchaser or any purchases made by an identifiable purchaser.

### Second Database

According to some embodiments of the invention a second database 152 stores a purchaser's personal information, credit card information and/or checking account information. There is no association of the information stored in the second database 152 with the AC and PIN codes stored in the first database 151. Nor is there an association of the information within the second database 152 with a purchaser's account or purchases.

### Third Database

According to some embodiments of the invention a third data base 153 is configured to store information related to purchase transactions. Information related to purchase transactions includes, for example, transaction identification, transaction type and amount of purchase. The third database 153 generally comprises a transaction log in which information related to transactions is stored. According to embodiments of the invention neither ACs nor PINs are stored in the third database 153. Instead the third database stores links to corresponding records in at least one of the first and second data bases associated with AC and PIN information. Similarly, according to some embodiments of the invention neither personal information nor credit card information is stored in the third database 153. Instead the third database stores internal links to corresponding records in at least one of the first and second databases.

According to embodiments of the invention first second and third databases 151, 152 and 153 are configured such that it is not possible to find a purchaser name, a corresponding AC and information related to anonymous purchases by looking only at the transaction table of the third database 153. Therefore no single database comprises both information about transactions or purchases and information about information about a purchaser who made the purchases or transactions. The databases are configured in accordance with the invention such that information in the databases is linkable by encryption keys.

There have thus been provided new and improved methods and systems for effecting anonymous purchase transactions on the Internet. While the invention has been shown and described with respect to particular embodiments, it is not thus limited. Numerous modifications, changes and enhancements will now be apparent to the reader.

What is claimed is:

1. A system for anonymously purchasing an item from an online merchant comprising:
means for receiving price information from said merchant system about an item selected for anonymous purchase by a purchaser;
means for effecting payment of said price;
means for providing an indication of said effected payment to said merchant system;
means for providing a first anonymous identifier to said purchaser;
means for providing a second corresponding anonymous identifier to said merchant site;
said merchant providing said item to said purchaser based upon matching said first anonymous identifier with said corresponding second anonymous identifier in response to receiving said payment indication.

2. A system for anonymously purchasing an item from an online merchant comprising:
an input port configured to receive item price information from a merchant system for an item selected for anonymous purchase by a purchaser;
a communication port configured to communicate with a payment provider to effect payment of said item price;
a message generator for providing a message indicating said effected payment to said merchant system;
an anonymous identification generator providing a first anonymous identifier and to said purchaser and a second corresponding anonymous identifier to said merchant system;
said merchant providing said item to said purchaser based upon matching said first anonymous identifier with said corresponding second anonymous identifier in response to receiving said payment indication.

3. A method for anonymously purchasing an item from an online merchant comprising steps of:
receiving price information from said merchant system about an item selected for anonymous purchase by a purchaser;
effecting payment of said price;
providing an indication of said effected payment to said merchant system;
providing a first anonymous identifier to said purchaser;
providing a second corresponding anonymous identifier to said merchant system;
said merchant system providing said item to said purchaser based upon matching said first anonymous identifier with said corresponding second anonymous identifier in response to receiving said payment indication.

4. A system for effecting anonymous purchase of items from an online merchant system comprising:
a first communication port configured to communicate with a merchant system to receive price information from said merchant system about an item selected for purchase by a purchaser;
a second communication port configured to communicate with a purchaser system;
a third communication port configured to communicate with a payment provider system to effect payment of said price from a purchaser;
said first communication port configured to provide an anonymous identifier to said purchaser system in response to receiving said payment;
means coupled to said merchant site for providing said payment to said merchant site;
means coupled to said merchant site for providing said anonymous identifier to said merchant site;
wherein said merchant system provides said item to said purchaser in response to said purchaser providing said anonymous identifier to said merchant system, said purchaser thereby remaining anonymous to said merchant.

5. A method for effecting anonymous purchase of items from an online merchant comprising steps of:
receiving price information from said merchant site about an item selected for purchase by a purchaser;
receiving payment of said price from said purchaser;
providing an anonymous identifier to said purchaser in return for receiving said payment;
providing said payment to said merchant site;
providing said anonymous identifier to said merchant site;
wherein said merchant site provides said item to said purchaser in response to said purchaser providing said anonymous identifier, said purchaser thereby remaining anonymous to said merchant.

6. A system for selling items online comprising:
means for providing information via the Internet about items for sale to a purchaser;
means for receiving information from a purchaser about at least one item selected for purchase by said purchaser;
means for providing information about the selected item to a second system;
means for redirecting the purchaser to a website provided by the second system;
means for receiving from said second system information about the status of payment for said item selected for purchase;
means for receiving from said second system first anonymous information related to said item selected for purchase;
means for receiving from a purchaser second anonymous information related to said item selected for purchase;
means for comparing said first anonymous information to said second anonymous information and
means for providing access to said purchased item to said purchaser when said first anonymous information matches said second anonymous information.

7. A method for selling items online comprising steps of:
providing information via the Internet about items for sale to a purchaser;
receiving information from a purchaser about at least one item selected for purchase by said purchaser;
providing information about the selected item to a second system;
redirecting the purchaser to a website provided by the second system;
receiving from said second system information about the status of payment for said item selected for purchase;
receiving from said second system first anonymous information related to said item selected for purchase;
receiving from a purchaser second anonymous information related to said item selected for purchase;
comparing said first anonymous information to said second anonymous information and
providing access to said purchased item to said purchaser when said first anonymous information matches said second anonymous information.
